(19) United States
(12) Patent Application Publication
(10) Pub. No.: US 2008/0195439 A1
(43) Pub. Date: Aug. 14, 2008

(54) ASSESSING POTENTIAL RISK SEVERITY FROM INVESTOR LAWSUITS

(76) Inventors: Benedick Fidlow, Cranford, NJ (US); Dustin E. Ng, Edison, NJ (US); Stephen C. Guijarro, Bayville, NY (US)

Correspondence Address: PATENT DOCKET CLERK;COWAN, LIEBOWITZ & LATMAN, P.C., 1133 AVENUE OF THE AMERICAS, NEW YORK, NY, 10036, US

(21) Appl. No.: 12/030,589

(22) Filed: Feb. 13, 2008

Related U.S. Application Data
(60) Provisional application No. 60/889,615, filed on Feb. 13, 2007.

(51) Int. Cl. G06Q 10/00; G06F 17/30

(52) U.S. Cl. 705/7; 707/102; 707/E17.009

(57) ABSTRACT

Methods and systems are provided for preparing a report providing at least one evaluation of a subject business entity's loss severity potential in the event of an insurable claim by one or more investors. Methods and systems are provided for producing a database for producing a report providing at least one evaluation of a subject business entity's loss severity potential in the event of an insurable claim by one or more investors.

This application claims the benefit of U.S. provisional application No. 60/889,615, filed Feb. 13, 2007 in the names of Benedick Fidlow, Dustin E. Ng and Stephen C. Guijarro.

### FIELD OF THE INVENTION

Methods and systems are provided for assessing potential risk severity from investor lawsuits.

### BACKGROUND OF THE INVENTION

One of the significant problems facing business entities is to deal with the threat of securities class action lawsuits against its officers and directors. It is common practice to procure directors and officers liability insurance (D&O insurance) to help defray the costs of defending and settling such claims. However, the premiums for such insurance are substantial and it is thus necessary to weigh such premium costs against the extent of insurance coverage to be obtained, particularly the liability limits and retentions of the insurance policy.

In the absence of reliable means to predict potential liability in these cases, many business entities have set such liability limits and retentions of the insurance they purchase based upon those carried by their peers. However, it is dangerous to adopt the liability limits of one's perceived peers, because they may be collectively mistaken. Further and perhaps more significantly, one business is not likely to conduct its affairs just as its peers do, so that risk factors that vary in dependence on such conduct are likely to indicate that it would be prudent for each business entity to select different parameters for its D&O liability insurance than those of its peers.

Without a reliable process for assessing the potential severity of a loss due to an investor lawsuit, selecting D&O liability insurance limits and retentions becomes like a game of darts played while blindfolded: a misguided decision can result in substantial financial “pain”, either due to underinsurance or the payment of excessive premiums.

What is needed, therefore, is a process for assessing such loss severity based on an objective evaluation of available information.

### DISCLOSURE

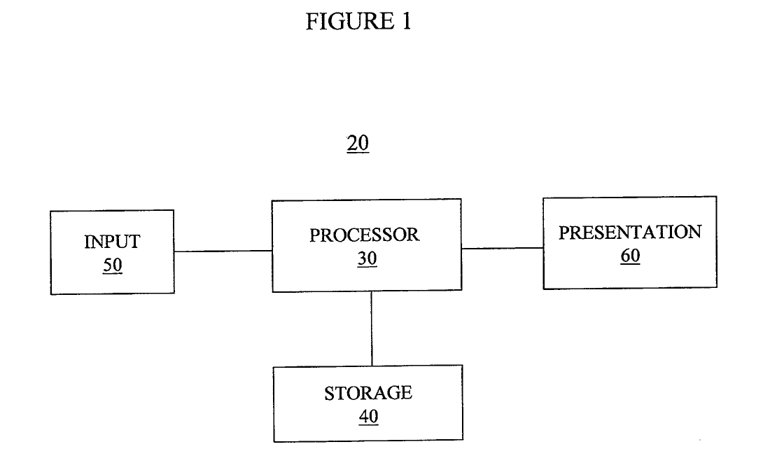

FIG. 1 is a block diagram of certain embodiments of a system for producing a report providing at least one evaluation of a business entity's loss severity potential in the event of an insurable claim by one or more investors;

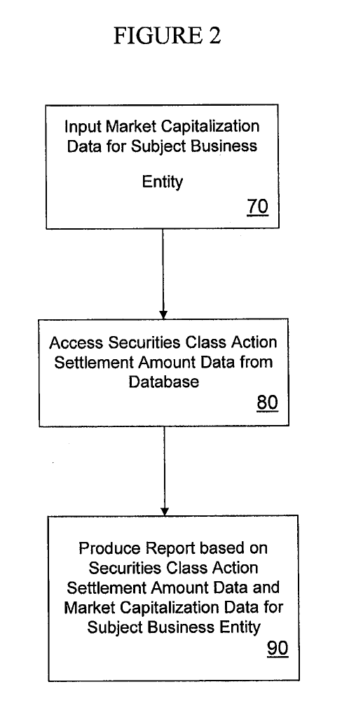

FIG. 2 illustrates certain embodiments of methods for operating the system of FIG. 1 to produce such reports;

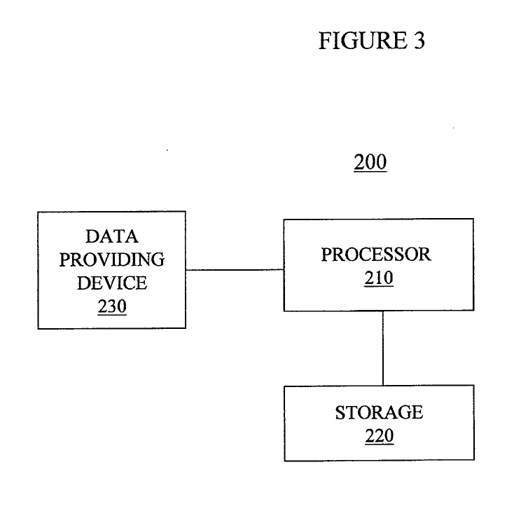

FIG. 3 is a block diagram of certain embodiments of a system for providing a database for producing a report providing at least one evaluation of a business entity's loss severity potential in the event of an insurable claim by one or more investors;

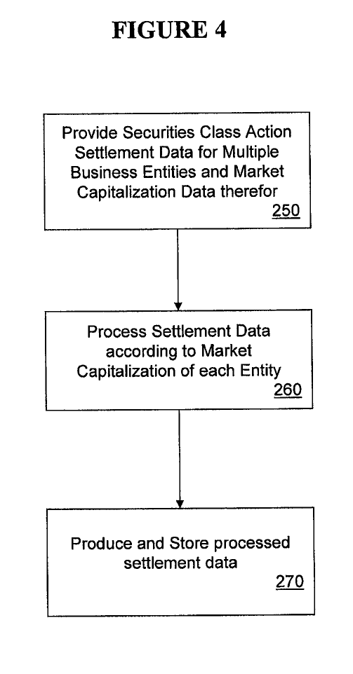

FIG. 4 illustrates certain embodiments of methods for providing such a database;

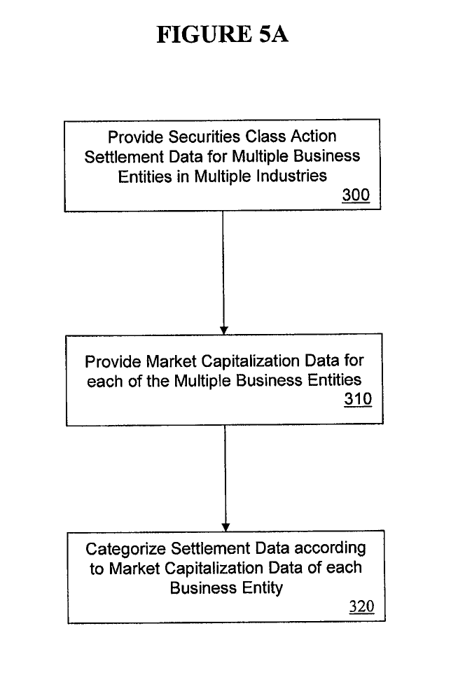

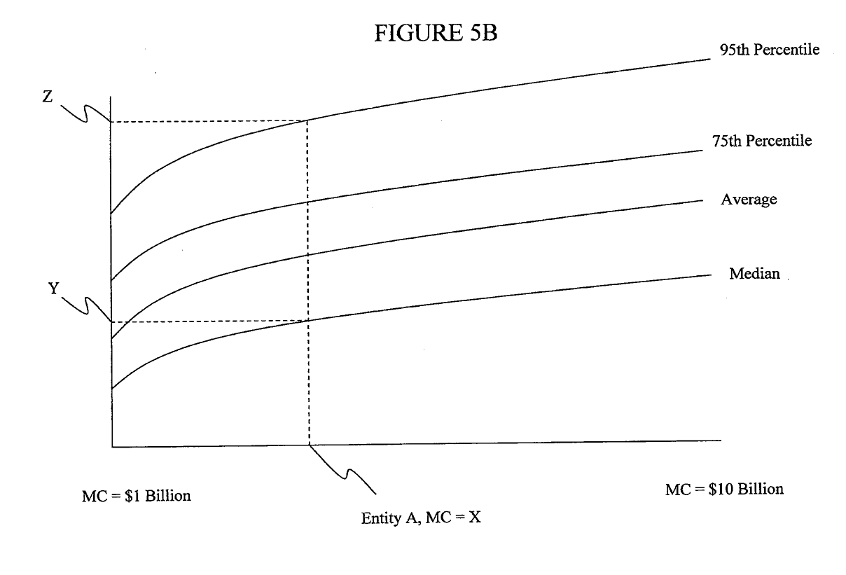

FIG. 5A illustrates certain embodiments of methods for producing such a database;

FIG. 5B provides examples of distribution level curve data or risk severity curve data;

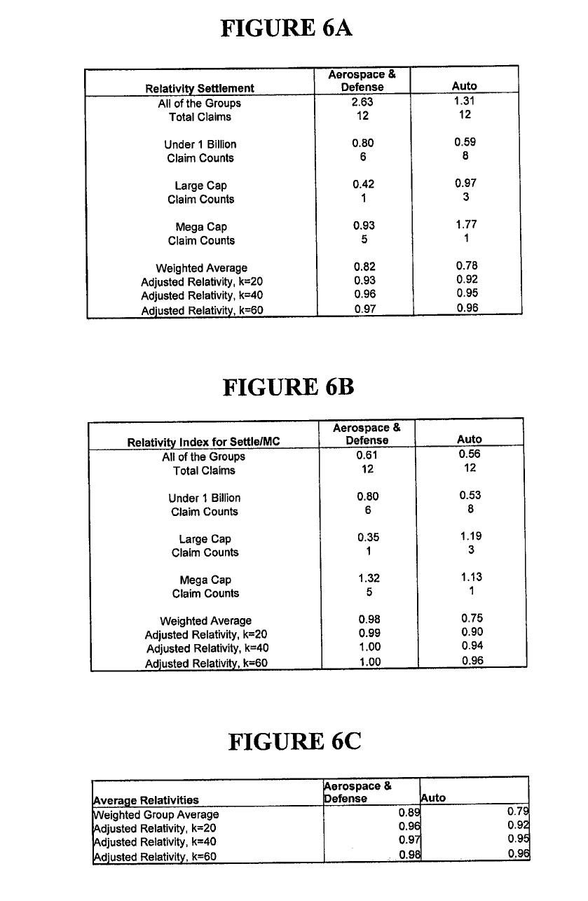

FIGS. 6A, 6B and 6C illustrate certain processing for producing industry relativity value data;

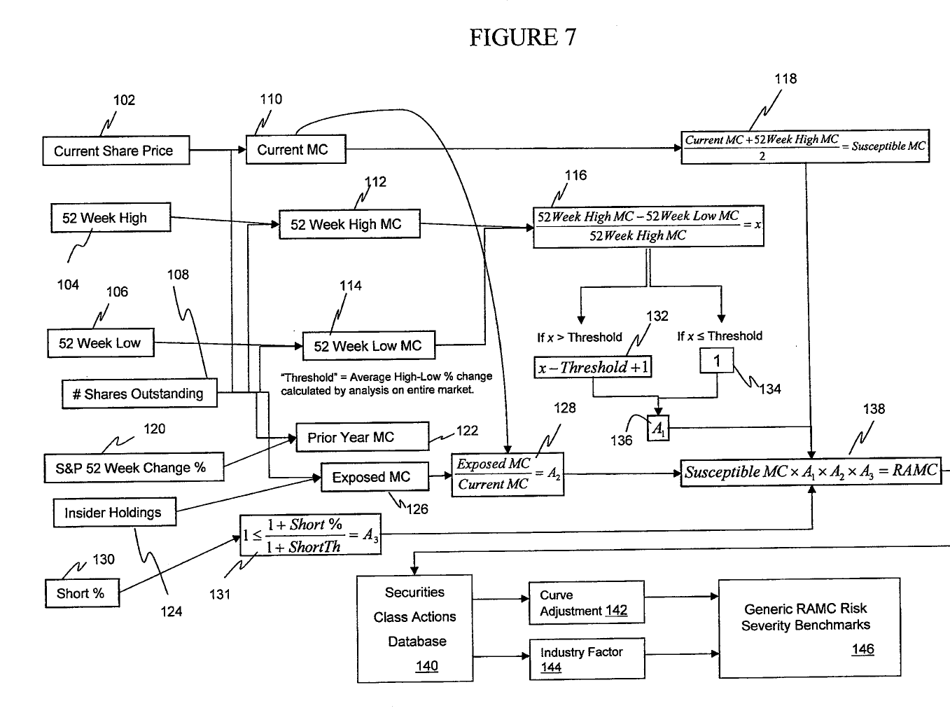

FIG. 7 illustrates certain processes for producing generic risk severity benchmark data;

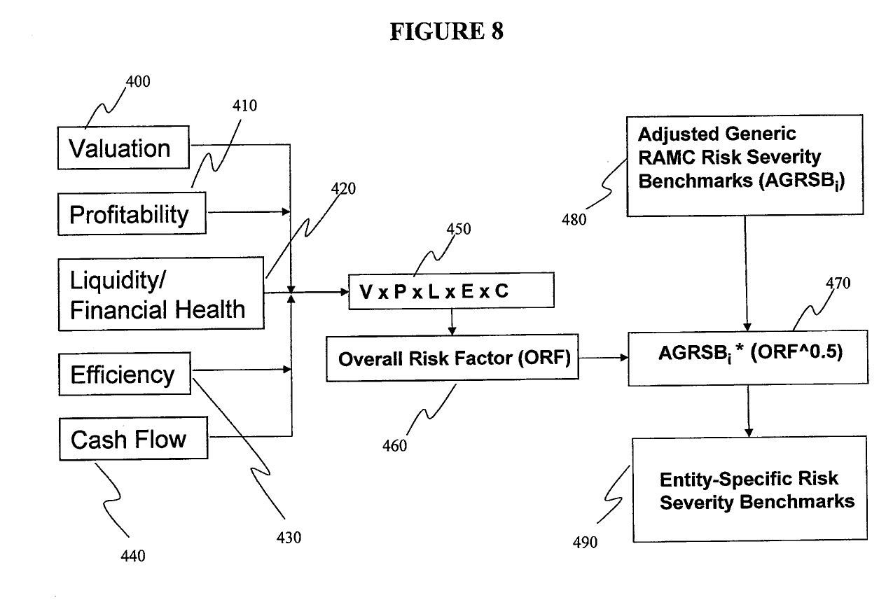

FIG. 8 illustrates certain processes for adjusting generic risk severity benchmark data based on selected conditions of a business entity;

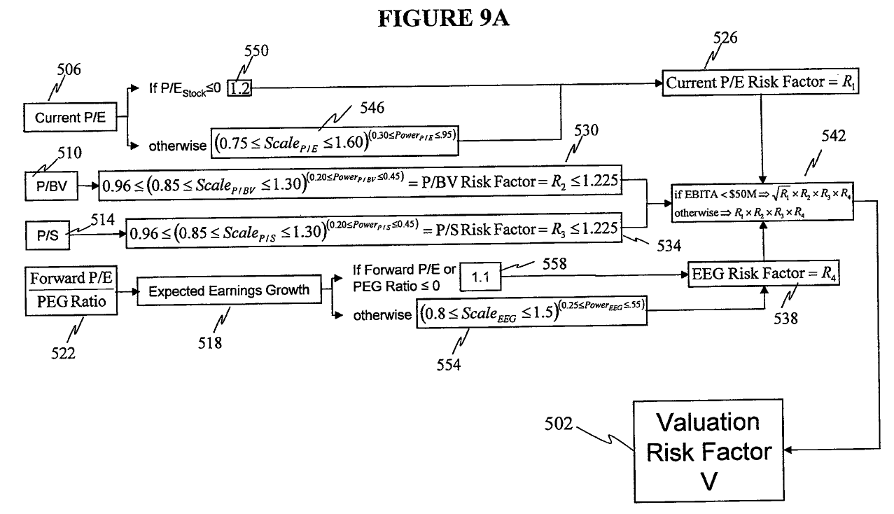

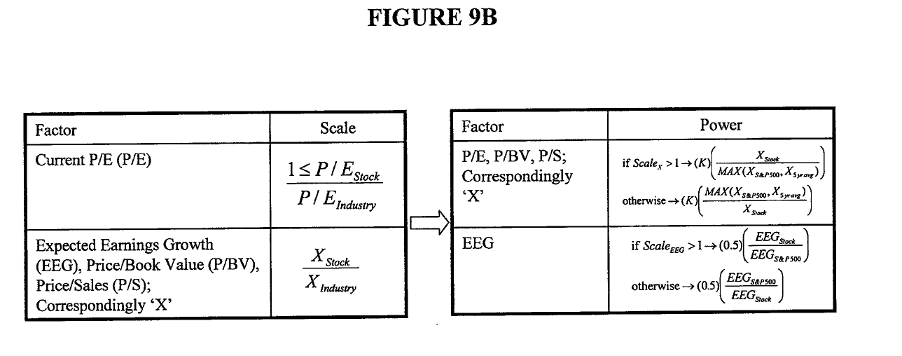

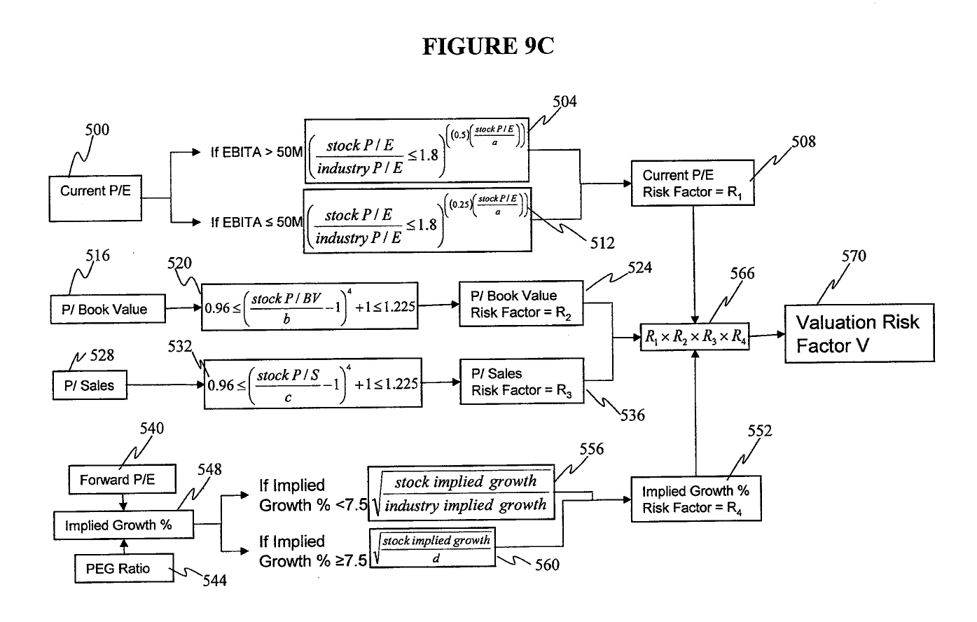

FIGS. 9A, 9B and 9C illustrate various methods for producing valuation factor data V for use in adjusting generic risk severity benchmark data;

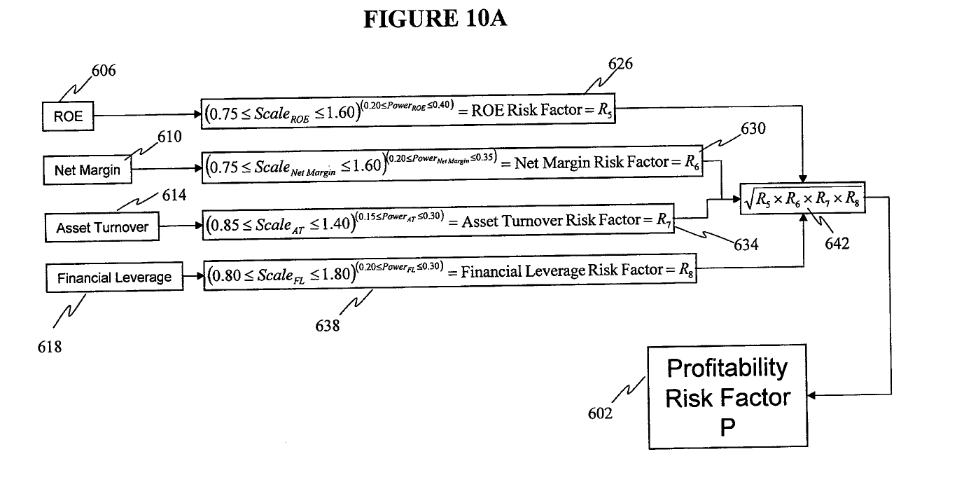

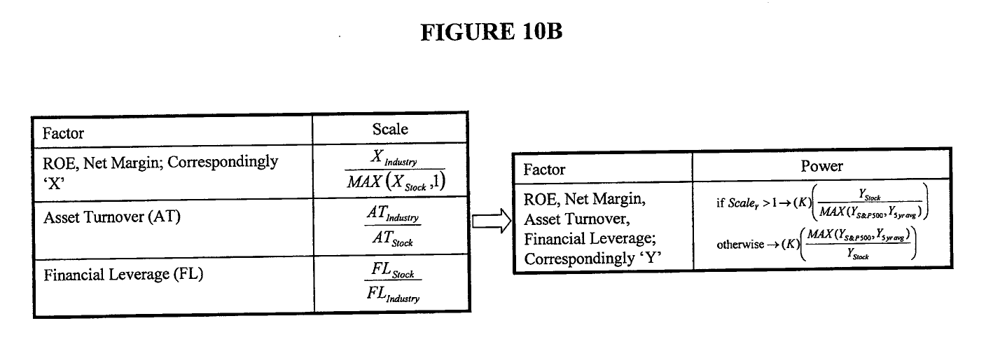

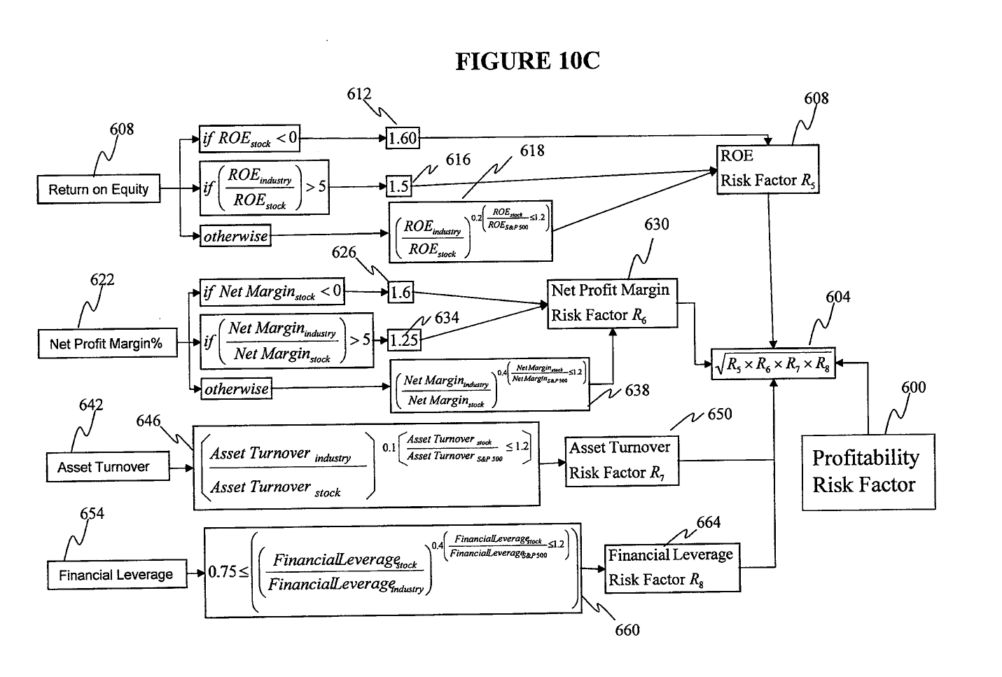

FIGS. 10A, 10B and 10C illustrate various methods for producing profitability factor data P for use in adjusting generic risk severity benchmark data;

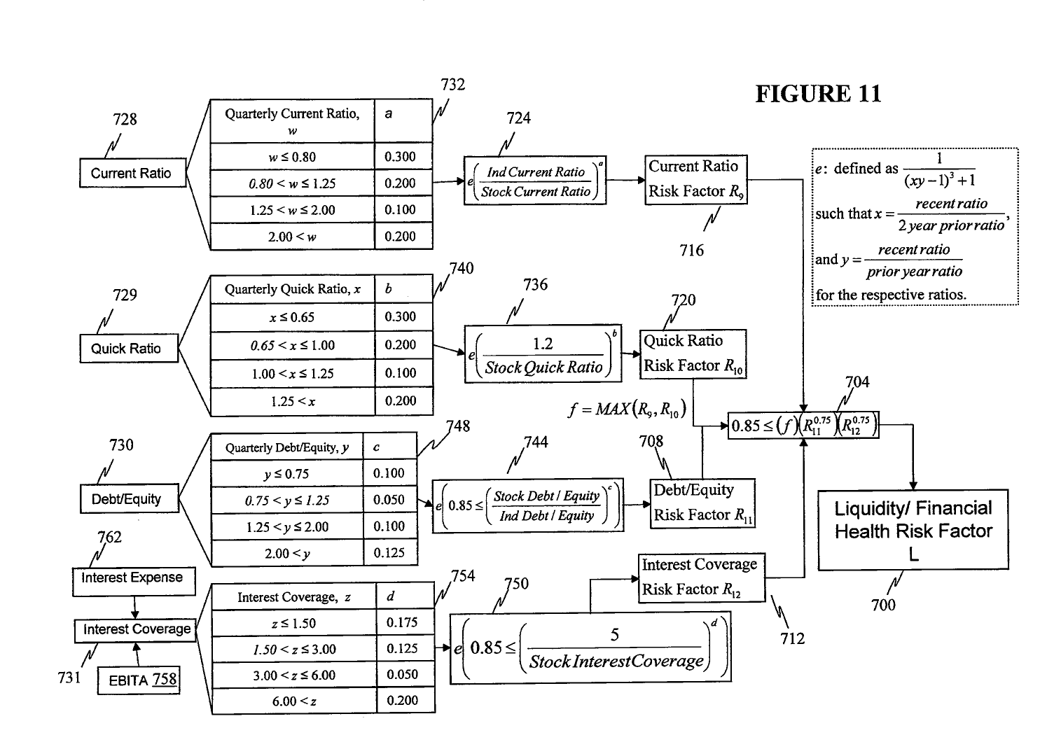

FIG. 11 illustrates various methods for producing liquidity and financial health factor data L for use in adjusting generic risk severity benchmark data;

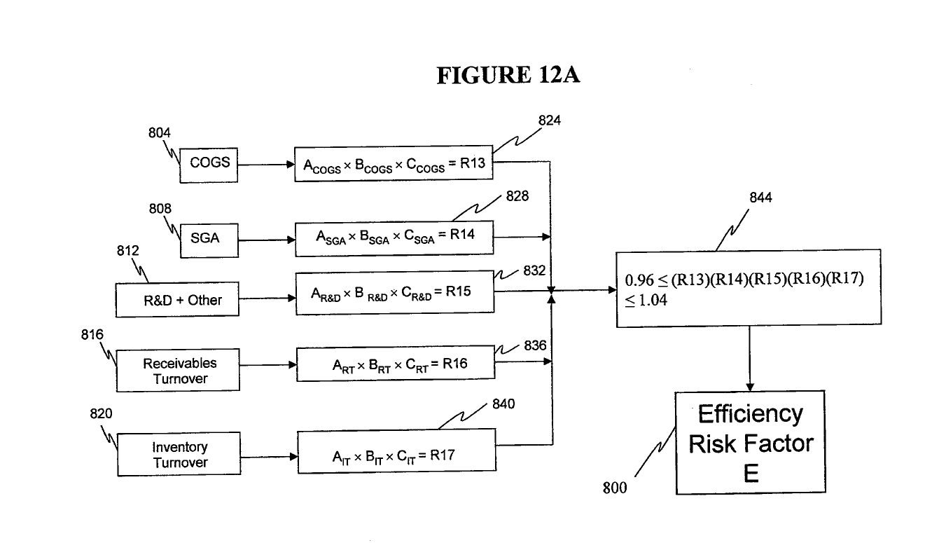

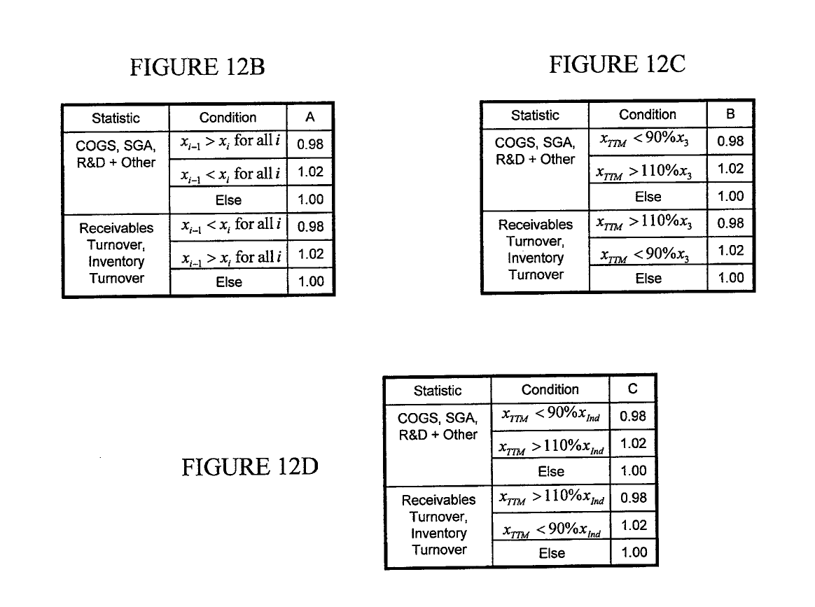

FIGS. 12A, 12B, 12C and 12D illustrate various methods for producing efficiency factor data E for use in adjusting generic risk severity benchmark data;

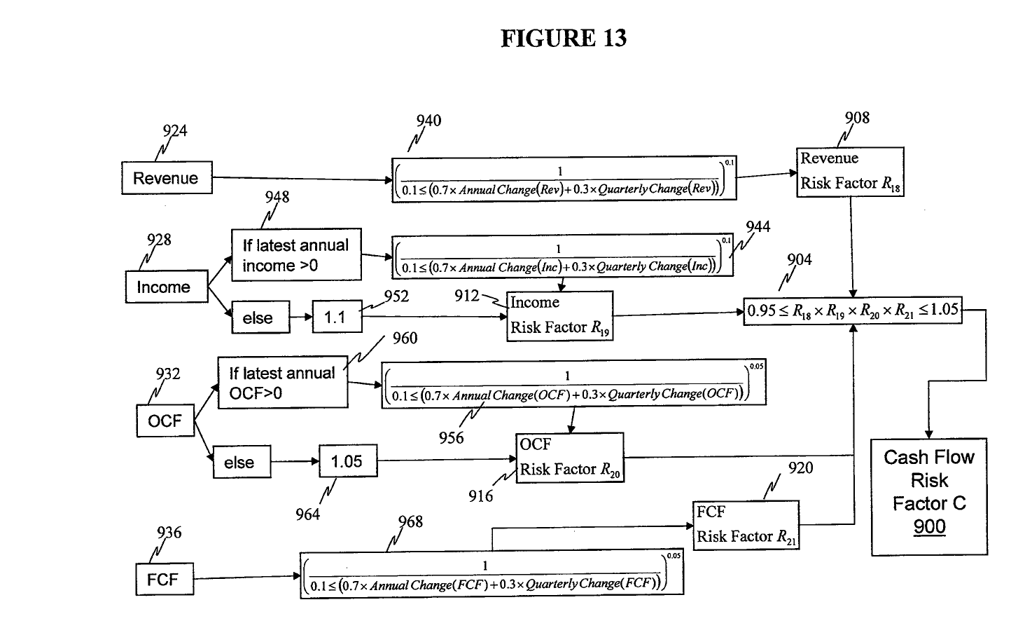

FIG. 13 illustrates various methods for producing cash flow factor data C for use in adjusting generic risk severity benchmark data;

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of corresponding information in a different physical form or forms.

The term “presentation data” as used herein means data to be presented to a user in any perceptible form, including but not limited to, visual form and aural form. Examples of presentation data include data displayed on a visual presentation device, such as a monitor, and data printed on paper.

The term “presentation device” as used herein means a device or devices capable of presenting data to a user in any perceptible form.

The term “database” as used herein means an organized body of related data, regardless of the manner in which the data or the organized body thereof is represented. For example, the organized body of related data may be in the form of one or more of a table, a map, a grid, a packet, a datagram, a frame, a file, an e-mail, a message, a document, a list or in any other form.

The term “insurable claim” as used herein means a claim for damages or other monetary relief of a kind that can be insured against, and includes both lawsuits and other legal proceedings, as well as asserted claims for monetary relief and potential claims for monetary relief;

The term “settlement” as used herein means a cost of satisfying an insurable claim by one or more investors, whether on terms agreed to by the parties or as determined by a court or other adjudicating entity having jurisdiction;

The term “network” as used herein includes both networks and internetworks of all kinds, including the Internet, and is not limited to any particular network or inter-network.

The terms “first”, “second”, “primary” and “secondary” are used to distinguish one element, set, data, object, step, process, activity or thing from another, and are not used to designate relative position or arrangement in time, unless otherwise stated explicitly.

The terms “coupled”, “coupled to”, and “coupled with” as used herein each mean a relationship between or among two or more devices, apparatus, files, circuits, elements, functions, operations, processes, programs, media, components, networks, systems, subsystems, and/or means, constituting any one or more of (a) a connection, whether direct or through one or more other devices, apparatus, files, circuits, elements, functions, operations, processes, programs, media, components, networks, systems, subsystems, or means, (b) a communications relationship, whether direct or through one or more other devices, apparatus, files, circuits, elements, functions, operations, processes, programs, media, components, networks, systems, subsystems, or means, and/or (c) a functional relationship in which the operation of any one or more devices, apparatus, files, circuits, elements, functions, operations, processes, programs, media, components, networks, systems, subsystems, or means depends, in whole or in part, on the operation of any one or more others thereof.

The terms “communicate,” “communicating” and “communication” as used herein include both conveying data from a source to a destination, and delivering data to a communications medium, system, channel, network, device, wire, cable, fiber, circuit and/or link to be conveyed to a destination. The term “communications” as used herein includes one or more of a communications medium, system, channel, network, device, wire, cable, fiber, circuit and link.

The term “processor” as used herein means processing devices, apparatus, programs, circuits, components, systems and subsystems, whether implemented in hardware, software or both, and whether or not programmable. The term “processor” as used herein includes, but is not limited to one or more computers, hardwired circuits, signal modifying devices and systems, devices and machines for controlling systems, central processing units, programmable devices and systems, field programmable gate arrays, application specific integrated circuits, systems on a chip, systems comprised of discrete elements and/or circuits, state machines, virtual machines, data processors, processing facilities and combinations of any of the foregoing.

The terms “storage” and “data storage” as used herein mean one or more data storage devices, apparatus, programs, circuits, components, systems, subsystems, locations and storage media serving to retain data, whether on a temporary or permanent basis, and to provide such retained data.

The size of a business entity's market capitalization has a major influence on the potential severity of the business entity's loss in the event of an investor lawsuit or claim. A method for preparing a report providing at least one evaluation of a subject business entity's loss severity potential in the event of an insurable claim by one or more investors makes use of a database of securities class action settlement amount data distributed into a plurality of categories according to market capitalization data of corresponding business entities. Category data for the subject business entity is produced based on market capitalization data thereof and the report is produced comprising projected settlement data representing at least one projected settlement amount based on the securities class action settlement amount data and the category data for the subject business entity.

A method for preparing a report providing at least one evaluation of a subject business entity's loss severity potential in the event of an insurable claim by one or more investors employs a database of securities class action settlement amount data for a plurality of business entities associated with data indicating a market capitalization of the respective business entities. Projected settlement data representing at least one projected securities settlement amount for the subject business entity is produced based on the securities class action settlement amount data in the database and market capitalization data representing a market capitalization of the subject business entity.

A system for preparing a report providing at least one evaluation of a subject business entity's loss severity potential in the event of an insurable claim by one or more investors comprises storage storing securities class action settlement amount data distributed into a plurality of categories according to market capitalization data of corresponding business entities, and further comprises a processor coupled with the storage to receive the securities class action settlement amount data. The system further comprises an input configured to receive market capitalization data of the subject business entity. The processor is coupled with the input to receive the market capitalization data therefrom and is configured to produce category data for the subject business entity based on the market capitalization data. The processor is further configured to produce the report comprising projected settlement data representing at least one projected settlement amount based on the securities class action settlement amount data and the category data for the subject business entity.

A system for preparing a report providing at least one evaluation of a subject business entity's loss severity potential in the event of an insurable claim by one or more investors comprises storage storing securities class action settlement amount data for a plurality of business entities associated with data indicating a market capitalization of the respective business entities, and further comprises a processor coupled with the storage to receive the securities class action settlement amount data. The system further comprises an input configured to receive market capitalization data of the subject business entity. The processor is coupled with the input to receive the market capitalization data therefrom and is configured to produce the report comprising projected settlement data representing at least one projected settlement amount based on the securities class action settlement amount data and the market capitalization data of the subject business entity.

FIG. 1 is a block diagram of certain embodiments of a system 20 for preparing such a report. In the embodiment of FIG. 1, a processor 30 is coupled with storage 40 storing a database of securities class action settlement amount data for a plurality of business entities. In certain embodiments, the class action settlement amount data is distributed into a plurality of categories according to market capitalization data of corresponding business entities. In certain embodiments, the securities class action settlement amount data is associated with data indicating a market capitalization of the respective business entities. In certain ones of the foregoing embodiments, processor 30 comprises a programmable processor and storage 40 stores instructions that are accessed by processor 30 and employed thereby to control its operations to prepare the report. In certain embodiments, storage 40 and processor 30 are housed in the same enclosure, while in other embodiments, storage 40 is housed separately and processor 30 accesses storage 40 via communications (not shown for purposes of simplicity and clarity) either as a peripheral device or via a network.

System 20 further comprises an input 50 that is operative to receive market capitalization data of a subject business entity for which the report is desired. Input 50 is coupled with processor 30 to provide the input market capitalization data thereto. In certain embodiments, input 50 comprises a keyboard or other manual data entry device coupled with processor 30 as a peripheral. In certain embodiments, input 50 comprises a storage such as a hard drive, either as a part of storage 40 or separate therefrom. In certain embodiments, input 50 comprises a device that reads the market capitalization data from a storage medium, such as a disk or tape. In certain embodiments, input 50 comprises a computer that communicates the market capitalization data to processor 30 via communications (not shown for purposes of simplicity and clarity) such as a network or data link. In certain embodiments, input 50 comprises two or more of the foregoing devices.

System 20 in certain embodiments comprises a presentation device 60 coupled with processor 30 to receive the report in the form of presentation data which device 60 employs to produce a presentation of the report to a user, such as an electronic visual display thereof, a report printed on paper, an aural report, or the like. In certain embodiments, presentation device 60 is housed in the same enclosure as processor 30. In certain embodiments, presentation device 60 is housed in a separate enclosure and is coupled with processor 30 as a peripheral. In certain embodiments, presentation device 60 receives the presentation data from processor 30 via communications (not shown for purposes of simplicity and clarity) such as a network or from storage (whether storage 40 or other storage).

A method of operating system 20 to produce such a report is illustrated in FIG. 2. As indicated at 70, market capitalization data for the business entity that is the subject of the report is input. Such data can be obtained from published stock market reports, company reports and financial analyses. For example, it may be obtained as data representing total market capitalization or by multiplying the total number of outstanding shares by share price. In certain embodiments, adjustments are made to such market capitalization data to account for market influences on the severity of the risks to the subject business entity; various such adjustments are described in connection with certain embodiments described hereinbelow. In certain embodiments, either such adjustments are not made or else made based on a different set of factors affecting risk.

Securities class action settlement amount data is accessed 80 from a database in storage to provide a basis for assessing the risk severity of the subject business entity having the input market capitalization. In certain embodiments, such securities class action settlement amount data comprises a settlement range distribution representing a range from a lowest settlement amount to a highest settlement amount, or for a portion of such a range, for a subset of business entities in the database having market capitalizations similar to that of the subject business entity. In certain embodiments, such securities class action settlement amount data comprises settlement amounts for each of a subset of business entities in the database having market capitalizations similar to that of the subject business entity, and one or more projected settlement amounts for the subject business entity are produced based on such settlement amounts. In certain ones of such embodiments, a plurality of such projected settlement amounts are produced for the subject business entity from the securities class action settlement amount data accessed from the database and representing a distribution of projected settlement amounts for the subject business entity ranging from relatively lower projected settlement amounts to relatively higher settlement amounts.

In certain embodiments, such securities class action settlement amount data comprises data representing at least one distribution level curve representing a predetermined point or interval or predetermined points or intervals within a plurality of settlement range distributions each corresponding to a different market capitalization or market capitalization range. In certain ones of such embodiments, a plurality of such distribution level curves are included in such securities class action settlement amount data, such that a first one of such distribution level curves represents a first predetermined point or interval within each of the settlement range distributions, such as an average settlement value, a median settlement value, a settlement value at the 25^{th}, 75^{th}, 95^{th} or other percentile within each of the settlement range distributions, and a second one of such distribution level curves represents a second predetermined point or interval within each of the same settlement range distributions. Any number of such distribution level curves may be produced or obtained and stored in the database, either as a mapping of market capitalization amounts to settlement amounts or as parameters defining such a curve using one or more predetermined formulas.

A report providing an evaluation of the subject business entity's loss severity potential is produced 90 based on the accessed securities settlement amount data and a market capitalization of the subject business entity. In certain embodiments, the report is produced from one or more distribution level curves or risk severity curves accessed from storage by extracting certain benchmark data therefrom based on a market capitalization of the subject business entity. In certain ones of such embodiments, such benchmark data comprises a settlement amount produced from the distribution level curve for the median of the distribution of settlement amounts at the market capitalization of the subject business entity, a settlement amount produced from the distribution level curve for the average settlement amount within the distribution of settlement amounts at such market capitalization, a settlement amount at the 75^{th} percentile thereof, and a settlement amount at the 95^{th} percentile thereof.

In certain embodiments, the report comprises a settlement range distribution, represented as a plurality of discrete values or as a continuous distribution curve. In certain embodiments, a subset of the business entities and settlement amounts in the database is selected and included as examples in the report, with or without the inclusion of further data. In certain embodiments, a subset of the business entities is selected from the database based on the similarities of their market capitalizations to that of the subject business entity and one or more measures of risk severity for the subject business entity are produced based on the selected subset to be included in the report.

A method of producing a database for producing a report providing at least one evaluation of a subject business entity's loss severity potential in the event of an insurable claim by one or more investors, comprises receiving or accessing securities class action settlement data for a plurality of business entities and market capitalization data for such business entities; storing the securities class action settlement data and the market capitalization data in storage; categorizing the securities class action settlement data for the plurality of business entities in selected categories based on the market capitalization data of such business entities to produce categorized settlement data; and storing the categorized settlement data and category data identifying the categories of the categorized settlement data, in the storage. In certain embodiments, at a later time further securities class action settlement data for a plurality of business entities and market capitalization data thereof are received or accessed and categorized to produce further categorized settlement data which are stored in the database.

A system for producing a database for producing a report providing at least one evaluation of a subject business entity's loss severity potential in the event of an insurable claim by one or more investors, comprises a data providing device, a processor coupled with the data providing device, and storage coupled with the processor; the processor being configured to receive securities class action settlement data for a plurality of business entities and market capitalization data for such business entities from the data providing device and to store the received data in the storage; the processor being configured to categorize the securities class action settlement data for the plurality of business entities in selected categories based on the market capitalization data of such business entities to produce categorized settlement data and to store the categorized settlement data and category data identifying the categories of the categorized settlement data, in the storage.

A method of producing a database for producing a report providing at least one evaluation of a subject business entity's loss severity potential in the event of an insurable claim by one or more investors, comprises receiving or accessing securities class action settlement data for a plurality of business entities and market capitalization data for such business entities; producing a plurality of settlement range distribution data for a plurality of market capitalization levels based on the securities class action settlement data and the market capitalization data; and storing the plurality of settlement range distribution data in storage. In certain embodiments, the settlement range distribution data comprises a plurality of settlement range distributions each representing a range from a lowest settlement amount to a highest settlement amount, or for a portion of such a range, for a corresponding market capitalization or market capitalization interval. In certain embodiments, the settlement range distribution data comprises a plurality of distribution level curves each representing a predetermined point or interval within a plurality of settlement range distributions each corresponding to a different market capitalization or market capitalization range. In certain embodiments, the securities class action settlement data and the market capitalization data are stored. At a later time, further securities class action settlement data for certain business entities and market capitalization data thereof are received or accessed and a further plurality of settlement range distribution data are produced based on the securities class action settlement data and the further securities class action settlement data of the various business entities, along with the corresponding market capitalization data thereof.

A system for producing a database for producing a report providing at least one evaluation of a subject business entity's loss severity potential in the event of an insurable claim by one or more investors, comprises a data providing device, a processor coupled with the data providing device, and storage coupled with the processor; the processor being configured to receive securities class action settlement data for a plurality of business entities and market capitalization data for such business entities from the data providing device; the processor being configured to produce a plurality of settlement range distribution data for a plurality of market capitalization levels based on the securities class action settlement data and the market capitalization data and to store the settlement range distribution data in storage.

Certain embodiments of a system 200 for producing such a database are illustrated in the block diagram of FIG. 3. The system 200 comprises a processor 210 coupled with a storage 220 and with a data providing device 230. In certain ones of such embodiments, processor 210 comprises a programmable processor and storage 220 stores instructions that are accessed by processor 210 and used thereby to produce the database. In certain embodiments, storage 220 and processor 210 are housed in the same enclosure, while in other embodiments, storage 220 is housed separately and processor 210 accesses storage 220 via communications (not shown for purposes of simplicity and clarity) either as a peripheral device or via a network.

FIG. 4 illustrates a method of operating system 200 of the FIG. 3 embodiments to produce the database. With reference both to FIG. 3 and FIG. 4, data providing device 230 provides 250 securities class action settlement data for a plurality of business entities and market capitalization data for such business entities to processor 210. Processor 210 stores the received data in storage 220, processes it 260 and stores the processed data in storage 220 to produce the database. In certain embodiments, processor 210 processes the settlement data by distributing the settlement data and data representing corresponding business entities into selected categories according to market capitalization thereof to produce categorized settlement data and stores 270 the categorized settlement data and category data identifying the categories of the categorized settlement data, in the storage 220. In certain embodiments, processor 210 processes the settlement data to produce a plurality of settlement range distribution data for a plurality of market capitalization levels and stores 270 the plurality of settlement range distribution data in storage 220.

In certain embodiments, data providing device 230 comprises a keyboard or other manual data entry device coupled with processor 210 as a peripheral. In certain embodiments, data providing device 230 comprises a storage such as a hard drive, either as a part of storage 220 or separate therefrom. In certain embodiments, data providing device 230 comprises a device that reads the securities class action settlement data for a plurality of business entities and market capitalization data for such business entities from a storage medium, such as a disk or tape. In certain embodiments, data providing device 230 comprises a computer that communicates such data to processor 210 via communications (not shown for purposes of simplicity and clarity) such as a network or data link. In certain embodiments, data providing device 230 comprises two or more of the foregoing devices.

Certain embodiments of the system and method of FIGS. 3 and 4 are now described with reference to FIGS. 5A and 5B. Referring first to FIG. 5A, in these certain embodiments securities class action settlement data for multiple business entities in multiple industries is gathered 300 from one or more sources, such as data provision services, public filings (e.g., SEC filings), company reports and the like, and is stored in storage 220. The amount of such data sought is dependent at least in part on the objective of gathering a statistically significant data amount. In certain ones of such embodiments, data from multiple sources is gathered to provide an ability to confirm the probable accuracy of the gathered data. In certain ones of such embodiments, where the settlement data does not represent a current settlement event (e.g., an agreed settlement or a judgment or award within the recent past), the settlement amounts are trended to current values.

Market capitalization data is gathered 310 for each of the business entities and stored in storage 220. Such data can be obtained from published stock market reports, company reports and/or financial analyses. For example, it may be obtained as data representing total market capitalization or by multiplying the total number of outstanding shares by share price. In certain embodiments, the market capitalization data is obtained as of a point in time prior to the initiation of the class action (e.g., six months before), the assumed average point in time where the entity would have purchased a D&O insurance policy exposed to the securities class action in question.

In certain embodiments, the securities class action settlement data is distributed 320 into multiple categories by processor 210 according to the market capitalization data of the corresponding business entities. This enables the production of a report of projected settlement amount data for a subject business entity based on a relationship of its market capitalization to the market capitalization of the business entities in the database. In certain embodiments, the securities class action settlement data is distributed into tertiles, namely, (1) a “Small Cap” category including business entities with a market capitalization less than a first market capitalization value (such as one billion dollars), (2) a “Large Cap” category including business entities with a market capitalization greater than or equal to the first market capitalization value but less than a second market capitalization value (such as ten billion dollars) greater than the first market capitalization value, and (3) a “Mega Cap” category including business entities with a market capitalization greater than or equal to the second market capitalization value (such as ten billion dollars). Such categorization is subject to modification in the event that new data added to the database indicates that selection of different categories for the securities class action settlement data will improve the ability of the database to predict risk severity. There may be the same or a different number of such new categories and such new categories may be partially or all different from those employed previously.

In certain embodiments, in order to provide measures of risk severity by market capitalization, data representing a plurality of distribution level curves or risk severity curves are produced by processor 210 for each category reflecting the distributions of the settlement data according to market capitalization of the entities within the category. These curves are stored in storage 220 for later use in producing the reports, either as parameters and formulas for defining the curves, or as a mapping of market capitalization data to settlement amounts. This makes it possible to provide a corresponding distribution of the settlement data for a particular entity having any market capitalization within the domain of the category. In certain embodiments, risk severity curve data are produced for each category representing (1) a median settlement value of the settlement data for each distribution within the category, (2) an average settlement value of the settlement data for each distribution within the category, (3) a 75% settlement value of the settlement data for each distribution within the category, and (4) a 95% settlement value of the settlement data for each distribution within the category. In certain embodiments, additional curves are produced, such as quartile curves. In certain embodiments, fewer curves are produced, while in others different curves are produced.

In certain embodiments, the settlement data either is not distributed into categories, or the categorization thereof is ignored, when the distribution level curve data or risk severity curve data are produced. In certain embodiments, a subset of the settlement data is selected for producing such curve data based upon the market capitalization of the entity for which the report is being produced, such as a subset in which the market capitalization of such entity is the median or average market capitalization in the subset, or a different value within the subset.

Additional or different curve data can be produced as desired to better reveal the distribution of exposures or risks for a business entity of a given market capitalization. For example, if the managers of a business desiring a report of its risk distribution wish an evaluation of such risks at different levels from those ordinarily or previously made available, then further data for curves representing settlement values at these new levels are produced to afford such evaluation. In certain cases where a report is requested or sought for a particular entity, a difference between settlement values revealed, for example, at the 75^{th} and 95^{th} percentiles, may be seen as too large to provide a desired degree of precision in the evaluation. In such cases, data for at least one further curve is produced, in this example, possibly a curve for the 85^{th} percentile or at a different intermediate level, to better reveal the nature of the distribution between the levels previously evaluated.

An exemplary representation of such risk severity curves for the large capitalization category is provided in FIG. 5B. In this example, if it is assumed that a risk distribution is desired for a business entity A having a market capitalization (MC) of X between $1 billion and $10 billion, the median settlement value as reflected by the settlements in the database and as represented by the median risk severity curve is seen to be Y, while the settlement value at the 95^{th} percentile of the distribution at a market capitalization (MC) of X, is shown at Z.

In certain embodiments, a different manner of representing the risk severity distributions is produced. In one such embodiment, the risk severity distributions are represented by curves representing a median risk severity value, a 25^{th} percentile risk severity value and a 75^{th} percentile risk severity value. In another, rather than produce curves representing risk severity points, distributions are produced independently for different market capitalization intervals or values.

A method for producing risk severity curve data in certain embodiments comprises dividing the settlement data (either within a predetermined category or within a newly selected category or subset) into market capitalization intervals, producing settlement distributions within such intervals as well as for the category or subset overall, assigning the settlement distribution for the category or subset overall to a representative market capitalization value (such as the average market capitalization value, the median market capitalization value or the market capitalization value of the mode) as benchmark or reference values and producing the risk severity curves so that they include such values and fairly reflect the manner in which the various produced settlement distributions vary.

To select such market capitalization intervals, in certain embodiments two criteria are applied: (1) the interval is selected so that the number of entities and corresponding settlements within the interval are statistically significant, and (2) corresponding benchmark values within adjacent intervals (for example, the median values) of the settlement distributions are sufficiently different so that they provide a clear indication of how the data varies from one interval to adjacent intervals. The manner of applying such criteria is readily understood by one ordinarily skilled in the art based on the teachings provided by the present application. In certain embodiments, the entities within the category are divided into tertiles or other sub-categories so that each includes approximately the same number of entities.

In certain embodiments, the data for curves representing the settlement distributions as median values, average values, quartile values, 95^{th} percentile values or other selected values, are produced as power functions whose values at an average market capitalization within the category are equal to the corresponding values produced for the category overall. The exponent of the power function is selected so that (1) the curve data reflects the manner in which the values it represents vary from interval to interval in the distributions of the settlement data for the respective intervals within the category, and (2) the values of the curve data at each end of the category's domain do not deviate greatly from the value of the corresponding curve data at the boundary of the adjacent category, if any. The manner in which such criteria are applied to produce the exponent is readily understood by one of ordinary skill in the art based on the teachings provided by the present application. In certain embodiments, the curve data are selected as power functions of the form SV=((MC/AMC)̂x)SV_{AMC}, where SV and SV_{AMC} represent, respectively, the median, average, 75^{th} percentile, 95^{th} percentile or other (as the case may be) of the settlement distribution for any business entity within the category having a market capitalization MC and a business entity having the average market capitalization (AMC) within the category, and x is an exponent whose value is selected using the curve selection criteria set forth hereinabove.

In certain embodiments, where it is apparent that the settlement data at one or more levels within the distributions diverges significantly from the trends apparent at other points in such distributions, such power functions are supplemented by adding a constant value to or subtracting a constant value from, the value of the power function to correct for such divergence. For example, if the settlement data at the 95^{th} percentile diverges significantly from the trends at other percentile levels, so that a power function following the settlement data at the 95^{th} percentile would yield overstated risk severity values, a constant is subtracted from the power function to adjust the 95^{th} percentile curve.

Settlement amounts for securities class actions can vary from industry to industry, so that it may be desired to adjust the risk severity values produced for a subject business entity depending on its industry. Such adjustments are made in certain embodiments by means of industry relativity values based on the relative differences in settlement amounts from industry to industry. Processes for producing industry relativity values in certain ones of such embodiments are explained with reference to FIGS. 6A, 6B and 6C.

FIGS. 6A through 6C provide exemplary values illustrating the production of industry relativity values for only the aerospace and automotive industries. However, the same process is applied for producing such values for each industry represented by the stored settlement data. With reference first to FIG. 6A, in certain embodiments, a set of relativity settlement values is produced for each industry group and for each market capitalization tertile within such group. That is, for each of the aerospace and defense industry group and the automotive industry group, an overall relativity value is produced and recorded in the row labeled “All of the Groups”. This value is produced by producing an average value of all settlement values within the respective industry and dividing it by the average settlement value for all entities within the database. Thus, the overall average relativity value for all groups is equal to 1.00.

However, these values are heavily influenced by the distribution of market capitalizations within each group, since settlement values in general vary with the market capitalizations of the entities involved in the securities class action claims. Each such entity is represented as a “claim” in FIG. 6A, so that there are five entities within the Mega Cap tertile of the aerospace and defense group. Therefore, a group heavily weighted towards larger capitalization entities, such as the aerospace and defense group, will likely have a higher average relativity value than a group having relatively fewer larger capitalization entities, such as the automotive group.

In certain embodiments, therefore, separate relativity values are produced for each tertile or other categorizations of market capitalizations for each group. Exemplary relativity values are contained in the table of FIG. 6A, for the Small Cap tertile in the row labeled “Under 1 Billion”, for the Large Cap tertile in the row labeled “Large Cap”, and in the Mega Cap tertile in the row labeled “Mega Cap”. These values are produced for each tertile (or other selected category) by dividing the average settlement value within that tertile and industry group by the average settlement value for all entities in the database within the same tertile. The overall relativity value for an entire group, therefore, is 1.00.

However, where, as in the examples shown in FIG. 6A, any of the tertiles (or other selected categories) have very few entities, as in the case of the Large Cap tertile of the aerospace and defense group, it may be preferred to employ a further or different process. An embodiment of such a process is also illustrated in FIG. 6A which combines the separate relativity values for each of the tertiles within a group weighted according to the number of entities in each such tertile. For example, in the case of the aerospace and defense group, the exemplary values may be combined by multiplying the relativity value of each tertile within the group by the number of claims (entities) in such tertile, summing the products of such multiplications and dividing the sum by the total number of entities within the group. That is, (0.80*6+0.42*1+0.93*5)/12=0.82, that is, the value indicated as “weighted average” in FIG. 6A. In certain embodiments, rather than produce relativity values for multiple categories, and overall average relativity value is produced for each industry.

Statistically, the credibility of the values produced for each industry group is strongly dependent on the number of entities in the group. That is, the smaller the number of entities in any given group, the less credible are its relativity values. Accordingly, in certain embodiments, the industry group relativity values are adjusted by applying a credibility parameter k dependent on the number of entities in the group, in accordance with the formula: WR(p/(p+k))+1.00(k/(p+k))=AR, where WR is the weighted relativity value for the group, p is the number of entities within the group, k is the selected credibility value and AR is the adjusted relativity value. FIG. 6A illustrates adjusted relativity values for the two industry groups produced using values of k equal to 20, 40 and 60, respectively. The value of k is selected based on criteria bearing on the credibility of the data for a given industry group. Such criteria include the amount of data available for the industry group; if it is sparse, this indicates a relatively low credibility. The presence of outliers among the data also tends to reduce the data's credibility, since outliers tend to skew values based on combinations of the data values. The selection of an appropriate value of k in each instance is readily carried out by one of ordinary skill in the art based on the teachings provided by the present application.

Another embodiment for producing industry relativity values is illustrated in FIG. 6B in which the settlement values are divided in each case by the corresponding entity's market capitalization before the relativity values are produced. This tends to normalize the distributions for differences in market capitalizations from group to group. Each of the values in FIG. 6B is produced in the same manner as the corresponding value of FIG. 6A, except that in the embodiment of FIG. 6B, the settlement values are first divided by the corresponding entity's market capitalization. For example, the relativity values are produced for each category in the embodiment of FIG. 6B by (1) dividing each settlement value within that category and industry group by the market capitalization of the entity, (2) dividing the average of the resulting values by the average of all settlement values in the database within the same category each divided by the market capitalization of its respective entity.

Further embodiments for producing industry relativity values are illustrated in FIG. 6C which combines the values produced in the embodiments of FIGS. 6A and 6B. This enables combining the values differently from category to category (e.g., from tertile to tertile) to compensate with greater precision for the extent to which market capitalizations vary from category to category. In certain ones of such embodiments, the relativity values from the table of FIG. 6A and from that of FIG. 6B are combined in a ratio of 90% to 10%, respectively, for the “Under 1 Billion” tertile, in a ratio of 50% to 50%, respectively, for the “Large Cap” tertile, and in a ratio of 60% to 40%, respectively, for the “Mega Cap” tertile.

The industry relativity values are stored in the database for use in producing industry-adjusted risk severity evaluation or benchmark data for the subject business entity by applying the relativity value data for its industry to non-industry specific risk severity evaluation or benchmark data. One manner of applying the industry relativity value data in accordance with certain embodiments is explained below in connection with FIG. 7.

As described hereinabove, a subject business entity seeking guidance in selecting D&O liability insurance limits and retentions can obtain useful data providing risk severity benchmarks for making such selections by means of the methods and systems disclosed herein. More specifically, data representing a market capitalization of the subject business entity is employed to access relevant securities class action settlement data from the database for providing such benchmarks. In certain embodiments, the market capitalization data of the subject business entity is used without modification to access the settlement data from the database.

In certain embodiments, before it is employed to access the database, the market capitalization data of the subject business entity is adjusted to take account of conditions in the securities marketplace that influence the risk severity of a securities class action against the subject business entity. Depending on the embodiment, one or more of the following market conditions are employed for this purpose: (1) price volatility of the subject business entity's securities (reflected, for example, by their high-low difference over the prior year), (2) amount or extent of short interest in the securities, (3) amount or extent of insider holdings compared to holdings by others, and (4) the risk severity in the subject business entity's industry as compared to other industries or all industries collectively.

In certain ones of such embodiments, prior to its use to access data from the database, the market capitalization data of the subject business entity is adjusted in the manner illustrated in FIG. 7, wherein the adjusted market capitalization data is referred to as the “risk adjusted market capitalization” or “RAMC”. In particular, the market conditions employed in the embodiment of FIG. 7 include: 1) the current price of a share of the subject business entity; 2) the highest value of the market capitalization for the last 52 weeks; 3) the lowest value of the market capitalization for the last 52 weeks; 4) the number of outstanding shares of the market capitalization; 5) the % change of the Standard & Poor's index over the past 52 weeks; 6) the current value of all insider holdings expressed in terms of monetary units, e.g., dollars; 7) the current % of the security held by insiders, e.g., directors, officers and/or employees of the business entity; and 8) the current % of the shares or units of the business entity that have been sold short. Though some eight market capital characteristics were included in this illustrative embodiment, it will be appreciated that one skilled in this art would understand that the described analysis could be carried out by less than or more of the noted market capitalization characteristics without departing from the teachings disclosed herein.

Data representing the current share price is entered 102 and is multiplied with the current number of outstanding shares of the business entity 108 to produce 110 data representing the current market capitalization. As indicated at 118, data representing the current value of the market capitalization is summed with data representing the 52 week high market capitalization, and the sum is divided by 2 to yield susceptible market capitalization data (“Susceptible MC”) for the subject business entity. The Susceptible MC is intended to provide an estimate of a hypothetical market capitalization that likely would be used by a court in determining damages in the event that both a securities class action suit were brought against the subject business entity and the court were to hold that the shareholders had successfully proved their claim against the business. It is reasonable to assume that a market capitalization value used by such a court in that event would be less than the market capitalization at the 52 week high stock price, but more than a current market capitalization, which presumably would have been suppressed by the hypothetical alleged wrongdoing. While in this embodiment, data representing the average of these two values is used as the Susceptible MC, the stock's history might indicate that a different value be used, for example where the market price of the stock had recently fallen after a steady climb in value over many months, or where the 52 week high had occurred early in the year and the stock's value had declined steadily since then. Where, for example, the subject business entity's industry is sensitive to business cycles and stock values have in general been declining in that industry, it may be more appropriate to a current or recent value of the stock's market capitalization as the Susceptible MC.

Data representing the 52 week high price of the business entity's security is entered 104 and is multiplied with the number of outstanding shares 108 to yield 112 data representing a 52 week high market capitalization. Similarly, data representing the 52 week low price for the security is multiplied by the number of outstanding shares 108 to yield 114 data representing a 52 week low market capitalization. The 52 week low market capitalization is subtracted 116 from the 52 week high market capitalization data and the difference is in turn divided by the 52 week high market capitalization to produce a quotient X. The quotient X of the aforesaid division is compared to a selected threshold. The selection of the threshold is based on one or more of a measured volatility of market capitalizations in the market overall and/or within a given market segment, such as the relevant industry of the subject business entity or a segment defined as a range of market capitalizations including that of the subject business entity. In certain embodiments, the average high-low percentage change of market capitalizations within the entire market or such market segment is used for this purpose. In certain ones of such embodiments, the threshold is selected as the average high-low percentage change for the entire market, increased by a percentage reflecting volatility due to market conditions, the characteristics of the relevant industry and/or the market capitalization of the subject business entity. A typical threshold produced in this manner can have a value of approximately 1.5 times such average high-low percentage change. If the quotient X is greater 132 than the produced threshold, first risk factor data A1 is produced by subtracting 132 the value of the threshold from the quotient X and adding that difference to 1. On the other hand, if the quotient X is less than or equal to the value of the threshold, the first risk factor data A1 is set 134 to 1.

To determine the value of second risk factor data A2, data representing the % change in the value of the Standard & Poors Index over the last 52 weeks is obtained or derived in step 120. The insider holdings in terms of the number of shares held by the officers, directors and employees of the subject business entity (in contrast to the shares held by the public) are obtained or determined 124. The exposed market capitalization is determined as the current market capitalization 110 less the value of all insider securities 124. The ratio of the exposed market capitalization to the total market capitalization is determined 128, to produce the second risk factor data A2.

To produce third risk factor data A3, data indicating a percent of the subject entity's securities that are sold short is input 130. As indicated at 131, this data is added to 1, before that sum is divided by a short threshold value ShortTh. The value of ShortTh is selected to represent an average of short positions across the broad stock market. Accordingly, if the average short position across the broad market is 5%, ShortTh is selected as 1.05. If the resultant quotient of the division 131 is equal to or greater than 1, the third risk factor data A3 is produced as such quotient; otherwise, A3 is set as 1. In effect, by using 1.05 as the divisor, up to a 5% short interest is treated as not affecting the risk severity. However, a different percentage may instead be employed if warranted by market conditions, or by conditions within the industry of the subject business entity. For example, in industries where stock prices tend to vary more than others over time, larger short interest levels may be present on average throughout the industry.

The risk adjusted market capitalization data (RAMC) for the subject business entity is produced 138 as the product of the Susceptible MC, and the risk factor data A1, A2 and A3. The RAMC is then used to retrieve or produce non-industry specific risk severity benchmark data 142 from the data stored in the securities class action database 140. In certain embodiments, the database 140 stores a plurality of settlement range distributions each representing a range from a lowest settlement amount to a highest settlement amount, or for a portion of such a range, for a corresponding market capitalization or market capitalization interval. In that case, the RAMC is used to access a corresponding settlement range distribution from database 140. In certain embodiments, the database 140 stores data representing a plurality of distribution level curves or risk severity curves each representing a predetermined point or interval within a plurality of settlement range distributions each corresponding to a different market capitalization or market capitalization range. In that case, the RAMC is used to access such curves from database 140 to produce data representing a plurality of non-industry specific risk severity benchmarks each representing a settlement amount for a given point or interval within a settlement range distribution for the RAMC used. Where the distribution level curves are stored as curve parameters and formulas, the RAMC is applied to the formula for each curve accessed, along with the relevant parameters, to produce the non-industry specific risk severity benchmark at the level of the distribution represented by such curve. Where the distribution level curves are stored as maps of market capitalization value data to settlement amount data, the RAMC is used to retrieve the corresponding settlement amount from each curve accessed to produce the benchmark.

In certain embodiments, the non-industry specific risk severity benchmark data accessed or produced using the RAMC are adjusted for variability of settlement values from industry to industry based on a selected one or ones of the industry relativity values produced using one of the processes described hereinabove in connection with FIGS. 6A through 6C. More specifically, in certain ones of such embodiments an industry relativity value produced for the industry of the subject business entity 144 in FIG. 7 is used as a factor to multiply each of the non-industry specific risk severity benchmarks produced for the subject business entity to effect such adjustment. In certain embodiments, the adjusted risk severity benchmarks thus produced are reported as the evaluations of the subject business entity's loss severity potential.

In certain embodiments, the adjusted risk severity benchmark data are adjusted to reflect the influences of still further conditions specific to the subject business entity on its risk severity. In various ones of such embodiments, one or more of the following conditions are employed to effect such further adjustment: (1) shareholders' expectations of the subject business entity's worth; (2) the quality of the subject business entity's earnings; (3) the liquidity and overall financial health of the subject business entity; (4) the subject business entity's efficiency in its use of its resources; and (5) the subject business entity's cash flow.

FIG. 8 illustrates one method of adjusting the adjusted risk severity benchmark data to take account of the effects of all five of such conditions of the subject business entity. As shown in FIG. 8, valuation factor data V is produced 400 representing the risk posed by shareholders' expectations of the entity's worth. Profitability factor data P is produced 410 representing the risk posed by the quality of the entity's earnings. Liquidity and overall financial health factor data L for the entity is produced 420. Efficiency factor data E is produced 430 representing how efficiently the entity uses its resources, and cash flow factor data C is produced 440 representing the quality of the entity's cash flow. Certain methods of producing the valuation factor V, the profitability factor P, the liquidity and overall financial health factor L, the efficiency factor E and the cash flow factor C are disclosed below in connection with FIGS. 9A through 13.

As indicated at 450 in FIG. 8, the factor data V, P, L, E and C are multiplied to produce overall risk factor data (ORF) 460. In certain embodiments, fewer than all of such factors are employed. The overall risk factor data is scaled by raising it to a power selected to reflect an appropriate degree of influence for these entity-specific factors. In certain embodiments, as indicated in FIG. 8 at 470, the selected power is 0.5, although other values for the power may be selected depending on the influence of the risk factors used as seen through experience. The ORF raised to the selected power multiplies 470 each of the adjusted generic risk severity benchmarks (AGRSBᵢ) 480 to yield entity-specific risk severity benchmark data 490. For example, if the median risk severity value for the subject business entity among the adjusted risk severity benchmarks is $10,000,000 and the ORF for the entity is 1.1, then the median value among the entity-specific risk severity benchmarks for the entity in the example of FIG. 8 is ($10,000,000)*(1.1̂0.5)=($10,000,000)*(1.0488)=$10,488,000.

FIG. 9A illustrates certain methods for producing the valuation factor data V of FIG. 8. Generally, the method of determining the valuation factor data V employs current and prospective value indicators for the entity, with comparisons to overall industry and/or market values indicators. With reference to FIG. 9A, in certain embodiments, the valuation factor data V (indicated at 502 in FIG. 9A) is produced based on current price/earnings ratio (P/E) data 506, price-to-book value ratio (P/BV) data 510, price-to-sales ratio (P/S) data 514 and expected earnings growth (EEG) data 518, in each case produced from data representing such values for the entity as well as for the entity's industry and/or the market overall. Current P/E risk factor data R₁ 526 is produced from the current P/E data 506. P/BV risk factor data R₂ 530 is produced from the P/BV data 510. P/S risk factor data R₃ 534 is produced from the P/S data 514, while an EEG risk factor R₄ 538 is produced from the EEG data 518. The valuation risk factor data V 502 is produced 542 as the product of the risk factor data R₁, R₂, R₃ and R₄, provided however, that if the entity's most recent quarterly EBITA is less than $50,000,000, then the factor R₁ is replaced by its square root in producing 542 the valuation risk factor V.

In certain embodiments, the current P/E ratio data 506 is produced, as indicated in FIG. 9B, by dividing data representing a current P/E of the entity by data representing a current P/E for the entity's industry overall, while in others data representing a current P/E for the market overall is used in place of the industry specific data. Where the current P/E ratio data 506 is produced as indicated in FIG. 9B, the value of K is selected as 0.5. In certain embodiments, the price-to-book value ratio data 510 is produced, as indicated in FIG. 9B, by dividing data representing a P/BV of the entity by data representing a P/BV for the entity's industry overall, while in others data representing a P/BV for the market overall is used in place of the industry specific data. Where the price-to-book value ratio data 510 is produced as indicated in FIG. 9B, the value of K is selected as 0.25. In certain embodiments, the price-to-sales ratio data 514 is produced, as indicated in FIG. 9B, by dividing data representing a P/S of the entity by data representing a P/S for the entity's industry overall, while in others data representing a P/S for the market overall is used in place of the industry specific data. Where the price-to-sales ratio data 514 is produced as indicated in FIG. 9B, the value of K is selected as 0.25 In certain embodiments, the expected earnings growth EEG data 518 is produced, as indicated in FIG. 9B, by obtaining or producing EEG data for the entity and EEG data for the entity's industry and dividing the former by the latter. In certain ones of such embodiments, the EEG data for the entity is produced by dividing a forward P/E for the entity by a price-earnings-growth (PEG) ratio for the entity, as indicated at 522 in FIG. 9A, while the EEG data for the entity's industry is produced in the same manner, but using an industry forward P/E and PEG ratio. In certain ones of such embodiments, EEG data for the market overall is used in place of EEG data for the entity's industry.

The current P/E risk factor data R₁ 526, as noted hereinabove and as seen in FIG. 9A, is produced from the current P/E data 506, which in turn is produced or obtained through a comparison of the price-earnings ratio of the entity's stock to a price-earnings ratio of the entity's industry or of the market overall. With reference to FIG. 9B, where this comparison is carried out by dividing the entity's P/E by the industry or market P/E, the value of the entity's P/E is constrained such that, if a value thereof is less than “1”, the value of the entity's P/E used to produce the current P/E data 506 is set as “1”. The current P/E data, produced as shown in FIG. 9B and as used to produce 546 the current P/E risk factor data R₁ 526, is represented by the variable “Scale_{P/E}” in FIG. 9A. More specifically, in certain embodiments, so long as the entity's P/E ratio is greater than “0”, the current P/E risk factor data R₁ 526 is produced from the current P/E data 506 (indicated as “Scale_{P/E}” in 546). Otherwise, the current P/E risk factor data R₁ 526 is set 550 as 1.1.

As indicated in 546 of FIG. 9A, in certain ones of such embodiments, when the P/E of the entity's stock is greater than “0”, the current P/E risk factor data R₁ 526 is produced by raising the value Scale_{P/E} to a power indicated as “Power_{P/E}”. As also shown in 546, the value of Scale_{P/E} is constrained so that it is set at a value “0.75” if its produced value is less than or equal to 0.75 and is set at a value “1.60” if its produced value is greater than or equal to 1.60. With reference again to FIG. 9B, if Scale_{P/E} is greater than “1”, then Power_{P/E} is produced as the factor 0.5 multiplied by the ratio of the entity's current P/E to the greater of the P/E of the S&P 500 stocks and the entity's five-year average P/E. If, however, Scale_{P/E} is less than or equal to “1”, then Power_{P/E} is produced as the factor 0.5 multiplied by the ratio of the greater of the P/E of the S&P 500 stocks and the entity's five-year average P/E to the entity's current P/E. With reference to FIG. 9A, the value of Power_{P/E} as used to produce 546 the data R₁ is constrained so that if its produced value is less than or equal to 0.30, Power_{P/E} is set as 0.30, and if its produced value is greater than or equal to 0.95, Power_{P/E} is set as 0.95.

The price-to-book-value (P/BV) risk factor data R₂, as seen in FIG. 9A, is produced from the P/BV data 510, which in turn is produced or obtained, as shown in FIG. 9B, through a comparison of the price-to-book-value ratio (P/BV) of the entity's stock to a price-to-book-value ratio (P/BV) of the entity's industry or of the market overall. In certain embodiments, this comparison is carried out by dividing the entity's P/BV by the industry or market P/BV. The P/BV data 510, produced as shown in FIG. 9B and as used to produce 530 the P/BV risk factor data R₂, is represented by the variable “Scale_{P/BV}” in FIG. 9A.

In certain ones of such embodiments, the P/BV risk factor data R₂ is produced 530 by raising the value Scale_{P/BV} to a power indicated as “Power_{P/BV}”, provided that if the value for R₂ so produced is less than or equal to 0.96, it is set at 0.96 and if the value for R₂ so produced is greater than or equal to 1.225, it is set at 1.225. As also shown in 530, the value of Scale_{P/BV} is constrained so that it is set at a value “0.85” if its produced value is less than or equal to 0.85 and is set at a value “1.30” if its produced value is greater than or equal to 1.30. With reference again to FIG. 9B, if Scale_{P/BV} is greater than “1”, then Power_{P/BV} is produced as the factor 0.5 multiplied by the ratio of the entity's current P/BV to the greater of the P/BV of the S&P 500 stocks and the entity's five-year average P/BV. If, however, Scale_{P/BV} is less than or equal to “1”, then Power_{P/BV} is produced as the factor 0.5 multiplied by the ratio of the greater of the P/BV of the S&P 500 stocks and the entity's five-year average P/BV to the entity's current P/BV. With reference to FIG. 9A, the value of Power_{P/BV} as used to produce 530 the data R₂ is constrained so that if its produced value is less than or equal to 0.20, Power_{P/BV} is set as 0.20, and if its produced value is greater than or equal to 0.45, Power_{P/BV} is set as 0.45.

As shown in FIG. 9A, the price-to-sales (P/S) risk factor data R₃ is produced from the P/S data 514, which in turn is produced or obtained, as shown in FIG. 9B, through a comparison of the price-to-sales ratio (P/S) of the entity's stock to a price-to-sales ratio (P/S) of the entity's industry or of the market overall. In certain embodiments, this comparison is carried out by dividing the entity's P/S by the industry or market P/S. The P/S data 514, produced as shown in FIG. 9B and as used to produce 534 the P/S risk factor data R₃, is represented by the variable “Scale_{P/S}” in FIG. 9A.

In certain ones of such embodiments, the P/S risk factor data R₃ is produced 534 by raising the value Scale_{P/S} to a power indicated as “Power_{P/S}”, provided that if the value for R₃ so produced is less than or equal to 0.96, it is set at 0.96 and if the value for R₃ so produced is greater than or equal to 1.225, it is set at 1.225. As also shown in 534, the value of Scale_{P/S} is constrained so that it is set at a value “0.85” if its produced value is less than or equal to 0.85 and is set at a value “1.30” if its produced value is greater than or equal to 1.30. With reference again to FIG. 9B, if Scale_{P/S} is greater than “1”, then Power_{P/S} is produced as the factor 0.5 multiplied by the ratio of the entity's current P/S to the greater of the P/S of the S&P 500 stocks and the entity's five-year average P/S. If, however, Scale_{P/S} is less than or equal to “1”, then Power_{P/S} is produced as the factor 0.5 multiplied by the ratio of the greater of the P/S of the S&P 500 stocks and the entity's five-year average P/S, to the entity's current P/S. With reference again to FIG. 9A, the value of Power_{P/S} as used to produce 534 the data R₃ is constrained so that if its produced value is less than or equal to 0.20, Power_{P/S} is set as 0.20, and if its produced value is greater than or equal to 0.45, Power_{P/S} is set as 0.45.

The EEG risk factor data R₄ 538, as seen in FIG. 9A, is produced from the expected earnings growth (EEG) data 518, which in turn, is produced in the manner described hereinabove. The EEG data, as used to produce 554 the EEG risk factor data R₄ 538, is represented by the variable “Scale_{EEG}” in FIG. 9A. More specifically, in certain embodiments, so long as the entity's Forward P/E and PEG ratio are each greater than “0”, the EEG risk factor data R₄ 538 is produced from the EEG data 518 (indicated as “Scale_{EEG}” in 554). Otherwise, the EEG risk factor data R₄ is set 558 as 1.1.

As indicated in 554 of FIG. 9A, in certain ones of such embodiments, so long as the entity's Forward P/E and PEG ratio are each greater than “0”, the EEG risk factor data R₄ 538 is produced by raising the value Scale_{EEG} to a power indicated as “Power_{EEG}”. As also shown in 554, the value of Scale_{EEG} is constrained so that it is set at a value “0.8” if its produced value is less than or equal to 0.8 and is set at a value “1.5” if its produced value is greater than or equal to 1.5. With reference again to FIG. 9B, if Scale_{EEG} is greater than “1”, then Power_{EEG} is produced as the factor 0.5 multiplied by the ratio of the entity's stock's EEG to the EEG of the S&P 500 stocks. If, however, Scale_{EEG} is less than or equal to “1”, then Power_{EEG} is produced as the factor 0.5 multiplied by the ratio of the S&P 500 stocks to the entity's stock's EEG. Referring again to FIG. 9A, the value of Power_{EEG} as used to produce 554 the data R₄ is constrained so that if its produced value is less than or equal to 0.25, Power_{EEG} is set as 0.25, and if its produced value is greater than or equal to 0.55, Power_{EEG} is set as 0.55.

FIG. 9C illustrates certain further methods for producing the valuation factor data V of FIG. 8. Current price/earnings ratio (P/E) data for the entity's stock is entered 500 and if its earnings before interest, taxes and amortization (EBITA) is greater than $50,000,000 (50M), then as indicated at 504, data representing the P/E ratio of the stock is divided by the average P/E ratio of the entity's industry and this ratio is compared to 1.8. If this ratio is less than or equal to 1.8, the value of the produced ratio is taken to the power of a value equal to (0.5×the stock P/E ratio divided by a value “a”) to yield 508 current P/E risk factor data R1. The value “a” is selected as the larger of the five year average of the stock's P/E ratio and the Standard & Poors P/E. If, however, the ratio of the stock's P/E to the average P/E of the entity's industry is greater than 1.8, then the current risk factor data R1 is produced as 1.8 taken to the power (0.5×the stock P/E ratio divided by the value “a”). On the other hand, if EBITA is less than or equal to 50M, then the current risk factor data R1 is produced 512 in the same manner as in 504, except that the value 0.25 is substituted for the value 0.5 in producing the exponent.

Price-to-book value risk factor data R2 is produced from price-to-book-value ratio data 516 for the entity's security and carrying out the process expressed in 520. That is, the price-to-book value ratio data is divided by a value “b” and 1 is subtracted from the result to yield a base value. The value b is selected as the larger of the five year average of the stock's price-to-book-value ratio and the Standard & Poors price-to-book-value ratio. Then the base value is raised to the 4^{th} power and 1 is added to the result to yield a provisional value of R2. If the provisional value of R2 is greater than or equal to 0.96 and less than or equal to 1.225, then the risk factor R2 is set 524 equal to the provisional value of R2. If, however, the provisional value of R2 is either less than 0.96 or greater than 1.225, then the value of the risk factor R2 is set 524 equal to 0.96 or 1.225, respectively.

Price-to-sales risk factor data R3 is produced from data representing a stock-price-to-sales ratio for the entity's security and carrying out the process expressed in 532. That is, the price-to-sales risk factor data R3 is produced 532 in the same manner as in 520, except that the stock-price-to-sales ratio is substituted for the price-to-book value ratio and a value “c” is substituted for the value b in the process expressed in 520. The value c is selected as the larger of the five year average of the entity's stock-price-to-sales ratio and the stock-price-to-sales ratio for the entity's industry overall.

Expected earnings growth factor data R4 is produced from publicly available data representing a forward-price-earnings ratio 540 and a price-earnings-growth ratio 544. First, data representing an expected earnings growth percentage for the entity's security is produced 548 by dividing the forward-price-earnings ratio 540 by the price-earnings-growth ratio 544. If the implied growth percentage is less than 7.5%, then the implied growth risk factor data R4 552 is produced 556 as the square root of the ratio of the implied growth percentage 548 and an industry expected earnings growth percentage for the entity's industry, obtained as an industry forward-price-earnings ratio divided by an industry forward-price-earnings ratio. If the expected earnings growth percentage is greater than or equal to 7.5%, then the expected earnings growth factor data R4 552 is produced 560 as the square root of the ratio of the implied growth percentage 548 and a value “d”. The value d is selected as the larger of the industry expected earnings growth percentage and an average of the expected earnings growth percentage of the entity's industry and the Standard & Poors 500 stocks. Data representing values of price-earnings-growth ratios and forward-price-earnings ratios for the entity, the entity's industry and the S & P 500 stocks are publicly available from sources such as Standard & Poors.

Once the various risk factor data R1, R2, R3 and R4 have been produced, they are multiplied together 566 to produce the valuation risk factor V data 570.

Data representing the profitability risk factor P provides a measure of the quality of the entity's earnings to assess the risk that its shareholders' earnings expectations will be disappointed in the future.

Certain methods for producing the profitability risk factor data P are illustrated in FIGS. 10A and 10B. Generally, the method of determining the profitability risk factor data V employs current and prospective value indicators for the entity, with comparisons to overall industry and/or market values indicators. With reference to FIG. 10A, in certain embodiments, the profitability risk factor data P (indicated at 602 in FIG. 10A) is produced based on return-on-investment (ROE) data 606, net margin data 610, asset turnover (AT) data 614 and financial leverage (FL) data 618, in each case produced from data representing such values for the entity as well as for the entity's industry and/or the market overall. ROE risk factor data R₅ is produced 626 from the ROE data 606. Net margin risk factor data R₆ is produced 630 from the net margin data 610. Asset turnover (AT) risk factor data R₇ is produced 634 from the AT data 614, while a financial leverage (FL) risk factor R₈ is produced 638 from the FL data 618. The profitability risk factor data P 602 is produced 642 as the square root of the product of the risk factor data R₅, R₆, R₇ and R₈.

In certain embodiments, the return-on-investment (ROE) data 606 is produced, as indicated in FIG. 10B, by dividing data representing an ROE of the entity's industry by data representing the greater of the entity's ROE and 1, while in others data representing an ROE for the market overall is used in place of the industry specific data. In certain embodiments, the net margin data 610 is produced, as indicated in FIG. 10B, by dividing data representing a net margin of the entity's industry overall by data representing the greater of a net margin of the entity and 1, while in others data representing a net margin for the market overall is used in place of the industry specific data. In certain embodiments, the AT data 614 is produced, as indicated in FIG. 10B, by dividing data representing an AT of the entity's industry by data representing an AT of the entity, while in others data representing an AT for the market overall is used in place of the industry specific data. In certain embodiments, the financial leverage data 618 is produced, as indicated in FIG. 10B, by obtaining or producing FL data for the entity and FL data for the entity's industry and dividing the former by the latter, while in others data representing an FL for the market overall is used in place of the industry specific data.

The ROE risk factor data R₅, as seen in FIG. 10A, is produced from the ROE data 606, which in turn is produced or obtained, as shown in FIG. 10B, through a comparison of an ROE of the entity's industry or of the market overall to an ROE of the entity. In certain embodiments, this comparison is carried out by dividing the industry or market ROE by the greater of the entity's ROE or “1”. The ROE data 606, produced as shown in FIG. 10B and as used to produce 626 the ROE risk factor data R₅, is represented by the variable “Scale_{ROE}” in FIG. 10A.

In certain ones of such embodiments, the ROE risk factor data R₅ is produced 626 by raising the value Scale_{ROE} to a power indicated as “Power_{ROE}”. As also shown in 626, the value of Scale_{ROE} is constrained so that it is set at a value “0.75” if its produced value is less than or equal to 0.75 and is set at a value “1.60” if its produced value is greater than or equal to 1.60. With reference again to FIG. 9B, if Scale_{ROE} is greater than “1”, then Power_{ROE} is produced as the factor K multiplied by the ratio of the entity's current ROE to the greater of the ROE of the S&P 500 stocks and the entity's five-year average ROE, where K is equal to 0.5. If, however, Scale_{ROE} is less than or equal to “1”, then Power_{ROE} is produced as the factor (K=0.5) multiplied by the ratio of the greater of the ROE of the S&P 500 stocks and the five-year average ROE of the entity, to the entity's current ROE. With reference to FIG. 10A, the value of Power_{ROE} as used to produce 626 the data R₅ is constrained so that if its produced value is less than or equal to 0.20, Power_{ROE} is set as 0.20, and if its produced value is greater than or equal to 0.40, Power_{ROE} is set as 0.40.

The Net Margin risk factor data R₆, as seen in FIG. 10A, is produced from the Net Margin data 610, which in turn is produced or obtained, as shown in FIG. 10B, through a comparison of a Net Margin of the entity's industry or of the market overall to a Net Margin of the entity. In certain embodiments, this comparison is carried out by dividing the industry or market Net Margin by the greater of the entity's Net Margin or “1”. The Net Margin data 610, produced as shown in FIG. 10B and as used to produce 630 the Net Margin risk factor data R₆, is represented by the variable “Scale_{Net Margin}” in FIG. 10A.

In certain ones of such embodiments, the Net Margin risk factor data R₆ is produced 630 by raising the value Scale_{Net Margin} to a power indicated as “Power_{Net Margin}”. As also shown in 630, the value of Scale_{Net Margin} is constrained so that it is set at a value “0.75” if its produced value is less than or equal to 0.75 and is set at a value “1.60” if its produced value is greater than or equal to 1.60. With reference again to FIG. 9B, if Scale_{Net Margin} is greater than “1”, then Power_{Net Margin} is produced as the factor K multiplied by the ratio of the entity's current Net Margin to the greater of the Net Margin of the S&P 500 stocks and the entity's five-year average Net Margin, where K is equal to 0.4. If, however, Scale_{Net Margin} is less than or equal to “1”, then Power_{Net Margin} is produced as the factor (K=0.4) multiplied by the ratio of the greater of the Net Margin of the S&P 500 stocks and the entity's five-year average Net Margin to the entity's current Net Margin. With reference to FIG. 10A, the value of Power_{Net Margin} as used to produce 630 the data R₆ is constrained so that if its produced value is less than or equal to 0.20, Power_{Net Margin} is set as 0.20, and if its produced value is greater than or equal to 0.35, Power_{Net Margin} is set as 0.35.

The asset turnover (AT) risk factor data R₇, as seen in FIG. 10A, is produced from the asset turnover (AT) data 614, which in turn is produced or obtained, as shown in FIG. 10B, through a comparison of an AT of the entity's industry or of the market overall to an AT of the entity. In certain embodiments, this comparison is carried out by dividing the industry or market AT by the entity's AT. The AT data 614, produced as shown in FIG. 10B and as used to produce 634 the AT risk factor data R₇, is represented by the variable “Scale_{AT}” in FIG. 10A.

In certain ones of such embodiments, the AT risk factor data R₇ is produced 634 by raising the value Scale_{AT} to a power indicated as “Power_{AT}”. As also shown in 634, the value of Scale_{AT} is constrained so that it is set at a value “0.85” if its produced value is less than or equal to 0.85 and is set at a value “1.40” if its produced value is greater than or equal to 1.4. With reference again to FIG. 10B, if Scale_{AT} is greater than “1”, then Power_{AT} is produced as the factor K multiplied by the ratio of the entity's current AT to the greater of an AT of the S&P 500 stocks and the entity's five-year average AT, where K is equal to 0.2. If, however, Scale_{AT} is less than or equal to “1”, then Power_{AT} is produced as the factor (K=0.2) multiplied by the ratio of the greater of the AT of the S&P 500 stocks and the entity's five-year average AT, to the entity's current AT. With reference to FIG. 10A, the value of Power_{AT} as used to produce 634 the data R₇ is constrained so that if its produced value is less than or equal to 0.15, Power_{AT} is set as 0.15, and if its produced value is greater than or equal to 0.30, Power_{AT} is set as 0.30.

The financial leverage (FL) risk factor data R₈, as seen in FIG. 10A, is produced 638 from the financial leverage (FL) data 618, which in turn is produced or obtained, as shown in FIG. 10B, through a comparison of an FL of the entity to an FL of the entity's industry or of the market overall. In certain embodiments, this comparison is carried out by dividing the industry or market FL by the entity's FL. The FL data 618, produced as shown in FIG. 10B and as used to produce 638 the FL risk factor data R₈, is represented by the variable “Scale_{FL}” in FIG. 10A.

In certain ones of such embodiments, the FL risk factor data R₈ is produced 638 by raising the value Scale_{FL} to a power indicated as “Power_{FL}”. As also shown in 638, the value of Scale_{FL} is constrained so that it is set at a value “0.80” if its produced value is less than or equal to 0.80 and is set at a value “1.80” if its produced value is greater than or equal to 1.80. With reference again to FIG. 10B, if Scale_{FL} is greater than “1”, then Power_{FL} is produced as the factor K multiplied by the ratio of the entity's current FL to the greater of an FL of the S&P 500 stocks and the entity's five-year average FL, where K is equal to 0.3. If, however, Scale_{FL} is less than or equal to “1”, then Power_{FL} is produced as the factor (K=0.3) multiplied by the ratio of the greater of the FL of the S&P 500 stocks and the entity's five-year average FL, to the entity's current FL. With reference to FIG. 10A, the value of Power_{FL} as used to produce 638 the data R₈ is constrained so that if its produced value is less than or equal to 0.20, Power_{FL} is set as 0.20, and if its produced value is greater than or equal to 0.30, Power_{FL} is set as 0.30.

FIG. 10C illustrates certain further methods for producing the profitability factor data P of FIG. 8. As indicated in FIG. 10C, the profitability risk factor data P 600 is produced 604 as the square root of the product of data representing four factors R5, R6, R7 and R8. Factor data R5 provides a measurement of risk that the entity's return on equity will prove disappointing to its shareholders and is produced from return on equity value data for the entity, which may be produced or obtained from values included in the entity's public reports or from publicly available information sources. If the return on equity value is less than or equal to zero, the factor data R5 is set 612 as 1.75. If the return on equity value is instead greater than zero, it is determined whether the ratio of data representing a return on equity for the entity's industry overall (likewise, publicly available information) to the entity's return on equity value is greater than 5. If so, the factor data R5 is set 616 as 1.5. Otherwise, the factor data R5 is produced 618 by taking the ratio of data representing a return on equity for the entity's industry overall to the entity's return on equity value, as a base, and raising it to a power determined as 0.2 multiplied by a selected value. The selected value is determined as the ratio of the entity's return on equity value to data representing a return on equity for the S & P 500 stocks overall, if such ratio is less than or equal to 1.2. Otherwise, the selected value is set as 1.2.

Factor data R6 provides a measurement of risk that the entity's net profit margin will lead to shareholder disappointment and is produced from net profit margin percentage data 622 for the entity, which may be produced or obtained from data included in the entity's public reports or from publicly available information sources. If the net profit margin percentage data is less than or equal to zero, the factor data R6 630 is set 626 as 1.6. If the net profit margin percentage data is instead greater than zero, it is determined whether the ratio of data representing a net profit margin percentage for the entity's industry overall, obtainable from publicly-available sources, to the entity's net profit margin percentage data is greater than 5. If so, the factor data R6 is set 634 as 1.25. Otherwise, the factor data R6 630 is produced 638 by taking the ratio of the data representing the net profit margin percentage for the entity's industry overall to the entity's net profit margin percentage, as a base, and raising it to a power determined as 0.4 multiplied by a selected value. The selected value is determined as the ratio of the entity's net profit margin percentage data to data representing a net profit margin percentage for the S & P 500 stocks overall (available, for example, from Standard & Poors), if such ratio is less than or equal to 1.2. Otherwise, the selected value is set as 1.2.

Factor data R7 provides a measurement of risk that arises if the entity's asset turnover 642 (which is publicly available information) is substantially below that of its industry, which can also indicate an enhanced risk that the entity's stock will underperform relative to its industry generally. To produce 646 the factor data R7 650, data representing a ratio of the asset turnover for the entity's industry overall (likewise, publicly available) to the entity's asset turnover, is taken as a base, and raised it to a power determined as 0.1 multiplied by a selected value. The selected value is determined as data representing the ratio of the entity's asset turnover to an asset turnover for the S & P 500 stocks overall, (obtainable from Standard & Poors), if such ratio is less than or equal to 1.2. Otherwise, the selected value is set as 1.2.

Factor data R8 provides a measurement of risk that arises if data representing the entity's financial leverage 654 (which is publicly available information) is substantially greater than data representing that of its industry, which provides a further indication of an enhanced risk that the entity's stock will underperform relative to its industry generally. To produce 660 the factor data R8 664, data representing a ratio of the financial leverage for the entity's industry overall (likewise, publicly available) to the entity's financial leverage, is taken as a base, and raised it to a power determined as 0.4 multiplied by a selected value. The selected value is determined as the ratio of the entity's financial leverage data to data representing a financial leverage for the S & P 500 stocks overall (obtainable from Standard & Poors), if such ratio is less than or equal to 1.2. Otherwise, the selected value is set as 1.2. However, if the value of data R8 produced in this manner is less than 0.75, the factor data R8 is set to 0.75.

FIG. 11 illustrates certain methods for producing the liquidity and financial health factor data L of FIG. 8. This data provides a measure of the entity's ability to withstand the fluctuations that may occur within its economic environment, and the risk that the value of its securities may suffer if it does not withstand these conditions without difficulty.

As shown in FIG. 11, the liquidity and financial health factor data L 700 is produced 704 based on debt-to-equity risk factor data R11 708, interest coverage risk factor data R12 712 and that one of current ratio risk factor data R9 716 and quick ratio risk factor data R10 720 having the greater value (represented as “f” in FIG. 11 at 704). The risk factor data R9, R10, R11 and R12 are, in turn, based on data representing the entity's current ratio 728, its quick ratio 729, its debt-to-equity ratio 730, and its interest coverage 731, respectively.

Factor data R9 provides a measurement of risk that the entity's liquidity will be inadequate to meet its current obligations, which could lead to a loss in the stock's market value. It is produced 724 from data representing the entity's current ratio 728, that is, the ratio of its current assets to its current liabilities as reported for the most recent quarter. Data representing an average current ratio for the entity's industry overall is divided by the entity's current ratio data and the result is raised to a power “a”, defined hereinbelow. The result is multiplied by a factor “e”, also defined hereinbelow, to produce 724 the current ratio risk factor data R9 716.

Data representing the power a is selected as one of four constant values depending on the value of the entity's current ratio. That is, if the current ratio data is less than or equal to 0.80, the value a is set 732 as 0.300; if the current ratio data is greater than 0.80 but less than or equal to 1.25, the value a is set as 0.200; if the current ratio data is greater than 1.25 but less than or equal to 2.00, the value a is set as 0.100; and if the current ratio data is greater than 2.00, the value a is set as 0.200.

Data representing the factor e is produced in the same manner in producing each of the risk factor data R9, R10, R11 and R12. That is, data representing the factor e is produced in each case from data representing a first value “x” and a second value “y”, each of which is produced in the same manner either from the current ratio data 728, the quick ratio data 729, the debt-to-equity ratio data 730 or the interest coverage data 731 (the “respective input value”), depending on whether data representing the factor e is to be used in producing the risk factor data R9, R10, R11 or R12, respectively. Data representing the first value x in each case is produced as the ratio of data representing a recent value of the respective input value (such as within one year of the present) to a change in the value thereof over the two most recent years. Data representing the second value y in each case is produced as data representing a recent value of the respective input value to a value thereof from the preceding year. Data representing the factor e is then produced as the reciprocal of the value ((xy−1)̂3+1).

Factor data R10 720 provides a further measure of a risk that the entity will be unable to meet its obligations, especially in the short term and is derived from data representing its quick ratio, that is, the ratio of its current assets (less inventory) to current liabilities. Data representing the value 1.2 is divided by the entity's quick ratio data and the result is raised to a power “b”, defined hereinbelow. The resulting data is multiplied by the data representing the factor e to produce 736 the quick ratio risk factor data R10 720. Data representing the power b is selected as one of four constant values depending on the value of the entity's quick ratio. That is, if the quick ratio data is less than or equal to 0.65, the value b is set 740 as 0.300; if the quick ratio data is greater than 0.65 but less than or equal to 1.00, the value b is set as 0.200; if the quick ratio data is greater than 1.00 but less than or equal to 1.25, the value b is set as 0.100; and if the quick ratio data is greater than 1.25, the value b is set as 0.200.

Factor data R11 provides a measurement of risk that the entity's debt load will impair its market value. It is produced 744 from data representing the entity's debt-to-equity ratio 730, that is, the ratio of its long term debt to the value of its shareholders' equity for the most recent quarter. Data representing the entity's debt-to-equity ratio is divided by data representing an average debt-to-equity ratio for the entity's industry overall and the result is raised to a power “c”, defined hereinbelow. The resulting data is multiplied by the factor e to produce 744 the debt-to-equity ratio risk factor data R11 708.

Data representing the power c is selected as one of four constant values depending on the value of the entity's debt-to-equity ratio data. That is, if the debt-to-equity ratio data is less than or equal to 0.75, the value c is set 748 as 0.100; if the debt-to-equity ratio data is greater than 0.75 but less than or equal to 1.25, the value c is set as 0.050; if the debt-to-equity ratio data is greater than 1.25 but less than or equal to 2.00, the value c is set as 0.100; and if the debt-to-equity ratio data is greater than 2.00, the value c is set as 0.125.

The interest coverage risk factor data R12 712 provides a measure of the risk that the entity will be unable to make its interest payments on its outstanding debt and is derived from data representing its interest coverage 731, that is, the ratio of data representing its earnings before interest, taxes and amortization (EBITA) 758 and data representing its interest expense 762 for corresponding periods, which are publicly available information. Where the interest coverage is not equal to zero, the interest coverage data is produced 731 as the sum of 80% of the average interest coverage for the prior three years and 20% of the interest coverage for the most recent quarter. Where the interest coverage is equal to zero, the interest coverage data is produced 731 as 0.98. To produce the factor data R12, the value 5 is divided by the entity's interest coverage data 731 and the result is raised to a power “d”, defined hereinbelow. The resulting data is multiplied by the factor e to produce 750 the interest coverage risk factor data R12 712. The power d is selected as one of four constant values depending on the value of the entity's interest coverage data. That is, if the interest coverage data is less than or equal to 1.50, the value d is set 754 as 0.175; if the interest coverage data is greater than 1.50 but less than or equal to 3.00, the value d is set as 0.125; if the interest coverage data is greater than 3.00 but less than or equal to 6.00, the value d is set as 0.050; and if the interest coverage data is greater than 6.00, the value d is set as 0.200.

FIG. 12A illustrates certain methods for producing the efficiency factor data E of FIG. 8. This data provides a measure how well the entity makes use of its resources in conducting its business, and the risk that the value of its securities may decline where the entity operates inefficiently.

The efficiency factor data E, 800 in FIG. 12A, is produced based on data representing the entity's cost of goods sold data (COGS) 804, its selling, general and administrative expense data (SGA) 808, its R&D and other expense data 812, its receivables turnover data (RT) 816 and its inventory turnover data (IT) 820. The COGS data 804 is converted 824 to factor data R13 by transforming the COGS data 804 into three different factors, A_{COGS} (produced in a manner illustrated in FIG. 12B), B_{COGS} (produced in a manner illustrated in FIG. 12C) and C_{COGS} (produced in a manner illustrated in FIG. 12D). The factor data R13 is then produced 824 by multiplying the factors A_{COGS}, B_{COGS} and C_{COGS}. The SGA data 808 is converted 828 in a similar fashion to factor data R14 by transforming the SGA data 808 into three different factors A_{SGA}, B_{SGA} and C_{SGA} in the same manner that the COGS data 804 is transformed into the factors A_{COGS}, B_{COGS} and C_{COGS}, respectively, and the factor data R14 is then produced 828 by multiplying the factors A_{SGA}, B_{SGA} and C_{SGA}. The R&D+other data 812 is similarly converted 832 to factor data R15 by transforming the R&D+other data 812 into three different factors A_{R&D}, B_{R&D} and C_{R&D} in the same manner that the SGA data 808 is transformed into the factors A_{SGA}, B_{SGA} and C_{SGA}, respectively, and the factor data R15 is then produced 836 by multiplying the factors A_{R&D}, B_{R&D} and C_{R&D}.

The factors A_{COGS}, A_{SGA} and A_{R&D} are each produced in the same manner which is illustrated in FIG. 12B. The COGS data 804, the SGA data 808 and the R&D+other data 812 (each represented as “x” in FIG. 12B) are obtained for each of the three prior years (i=1, 2, 3, . . . , with 1 representing the earliest year) and for the trailing twelve months (i=TTM). In each case the factor A is selected (1) as the value 0.98 if xᵢ₋₁>xᵢ for all i, (2) as the value 1.02 if xᵢ₋₁<xᵢ for all i, or (3) as the value 1.00 if neither of the foregoing conditions obtains.

The factors B_{COGS}, B_{SGA} and B_{R&D} are each produced in the same manner which is illustrated in FIG. 12C. The COGS data 804, the SGA data 808 and the R&D+other data 812 (each represented as “x” in FIG. 12C) are obtained for the most recent year (i=3) as well as for the trailing twelve months (i=TTM). In each case the factor B is selected (1) as the value 0.98 if x_{TTM}<0.90x₃, (2) as the value 1.02 if x_{TTM}>1.10x₃, or (3) as the value 1.00 if neither of the foregoing conditions obtains.

The factors C_{COGS}, C_{SGA} and C_{R&D} are each produced in the same manner which is illustrated in FIG. 12D. The COGS data 804, the SGA data 808 and the R&D+other data 812 (each represented as “x” in FIG. 12D) are obtained for the trailing twelve months (i=TTM), as well as the corresponding data for the entity's industry overall (i=IND). In each case the factor C is selected (1) as the value 0.98 if x_{TTM}<0.90x_{IND}, (2) as the value 1.02 if x_{TTM}>1.10x_{IND}, or (3) as the value 1.00 if neither of the foregoing conditions obtains.

The RT data 816 is converted 836 to factor data R16 by transforming the RT data 816 into three different factors, A_{RT} (produced in a manner illustrated in FIG. 12B), B_{RT} (produced in a manner illustrated in FIG. 12C) and C_{RT} (produced in a manner illustrated in FIG. 12D). The factor data R16 is then produced 836 by multiplying the factors A_{RT}, B_{RT} and C_{RT}. The IT data 820 is converted 840 in a similar fashion to factor data R17 by transforming the IT data 820 into three different factors A_{IT}, B_{IT} and C_{IT} in the same manner that the RT data 816 is transformed into the factors A_{RT}, B_{RT} and C_{RT}, respectively, and the factor data R17 is then produced 840 by multiplying the factors A_{IT}, B_{IT} and C_{IT}.

The factors A_{RT} and A_{IT} are each produced in the same manner which is illustrated in FIG. 12B. The RT data 816 and the IT data 820 (each represented as “x” in FIG. 12B) are obtained for each of the three prior years (i=1, 2, 3, with 1 representing the earliest year) and for the trailing twelve months (i=TTM). In each case the factor A is selected (1) as the value 0.98 if xᵢ₋₁<xᵢ for all i, (2) as the value 1.02 if xᵢ₋₁>xᵢ for all i, or (3) as the value 1.00 if neither of the foregoing conditions obtains.

The factors B_{RT} and B_{IT} are each produced in the same manner which is illustrated in FIG. 12C. The RT data 816 and the IT data 820 (each represented as “x” in FIG. 12C) are obtained for the most recent year (i=3) as well as for the trailing twelve months (i=TTM). In each case the factor B is selected (1) as the value 0.98 if x_{TTM}>1.10x₃, (2) as the value 1.02 if x_{TTM}<0.90x₃, or (3) as the value 1.00 if neither of the foregoing conditions obtains.

The factors C_{RT} and C_{IT} are each produced in the same manner which is illustrated in FIG. 12D. The RT data 816 and the IT data 820 (each represented as “x” in FIG. 12D) are obtained for the trailing twelve months (i=TTM), as well as the corresponding data for the entity's industry overall (i=IND). In each case the factor C is selected (1) as the value 0.98 if x_{TTM}>1.10x_{IND}, (2) as the value 1.02 if x_{TTM}<0.90x_{IND}, or (3) as the value 1.00 if neither of the foregoing conditions obtains.

With reference again to FIG. 12A, the efficiency factor data E 800 is produced 844 as the product of the factors R13, R14, R15, R16 and R 7, provided however, that (1) if such product is less than 0.96, the value of E is selected as 0.96, and (2) if such product is greater than 1.04, the value of E is selected as 1.04.

FIG. 13 illustrates certain methods for producing the cash flow factor data C of FIG. 8. This data provides a measure of the inflow and outflow of money resulting from the entity's operations, and the risk that the value of its securities may suffer where cash flow is inadequate.

The cash flow factor data C, 900 in FIG. 13, is produced 904 as the product of data representing four cash flow factors: data representing a revenue risk factor R18, 908 in FIG. 13; data representing an income risk factor R19, 912 in FIG. 13; data representing an operating cash flow (OCF) risk factor R20, 916 in FIG. 13; and data representing a free cash flow risk factor (FCF) R21, 920 in FIG. 13. The cash flow factors R18, R19, R20 and R21 are, in turn, based on data representing the entity's revenue 924, its income 928, its operating cash flow 932 and its free cash flow 936, respectively.

In order to accord appropriate emphasis to the cash flow risk factor data C, as compared to the factor data V, P, L and E, the cash flow risk factor data C is constrained to fall within a range of values. In certain embodiments, this range of values is centered on the value “1”, and in certain ones of such embodiments, is selected as 0.95 to 1.05. However, it will be appreciated that this range may be selected differently, depending on the emphasis accorded to the factor data C as compared to the remaining factors. It will be appreciated that other methods may be employed to accord varying, limited or equal emphasis to one or more of the factor data V, P, L, E and C, such as by multiplying the same by a factor selected to apply the desired emphasis.

The revenue risk factor data R18 is produced 940 in certain embodiments by selecting or producing data representing a trend or trends in the entity's revenue. In certain embodiments, this data is produced from a ratio of current period revenue to revenue from a prior period. In certain ones of such embodiments, annual revenue change data is produced as an average of two ratios: a ratio of revenue from the most recent reporting year to that of the prior year and a ratio of such prior year's revenue to that of its prior year. In certain ones of such embodiments, the annual revenue change data is produced as a ratio of revenue from the most recent reporting year to that of the prior year. In certain ones of such embodiments, the quarterly revenue change data is produced as an average of two ratios: a ratio of revenue from the most recent reported quarter to that of the prior quarter and a ratio of the corresponding quarter's revenue in the prior year to that of the immediately preceding quarter. In certain ones of such embodiments, the quarterly revenue change data is produced as a ratio of revenue from the most recent reported quarter to that of the prior quarter.

In certain embodiments, the revenue risk factor data 908 is produced 940 by averaging the annual change data and the quarterly change data to produce revenue change value data in a manner that emphasizes the revenue trend in the more recent time period. In certain ones of such embodiments, revenue change value data is produced as the sum of the annual change data multiplied by a decimal between zero and one (e.g., 0.7) and the quarterly change data multiplied by the complement of such decimal (e.g., 0.3). Other decimal values may be selected, depending on the extent to which the more recent revenue data is to be emphasized. However, the revenue change value data may instead be produced from either the annual revenue change data or the quarterly change data alone, or else from one or more different periods, either alone or in combination with one or more others thereof, or with either or both of the annual revenue change data or the quarterly revenue change data. In any event, the revenue change value data is constrained so that it is greater than or equal to 0.1, representing an average 90% decrease in revenue.

In certain embodiments, the revenue risk factor data R18 is produced as the reciprocal of the revenue change value data raised to a selected power which serves to scale the factor data R18 to give it appropriate emphasis in the production of the cash flow risk factor data C along with data representing the three other risk factors R19, R20 and R21. In certain ones of such embodiments, the selected power serves to scale the reciprocal of the revenue change value data to a relatively narrow range of values about the value “1”, so that the selected power is obtained as a value between “0” and “1”, such as 0.1.

The income risk factor data R19 (912 in FIG. 13) is produced 944 in certain embodiments by selecting or producing data representing a trend or trends in the entity's income. In certain embodiments, this data is produced from a ratio of current period income data to data representing income from a prior period. In certain ones of such embodiments, annual income change data is produced as an average of two ratios: a ratio of data representing income from the most recent reporting year to that of the prior year and a ratio of data representing such prior year's income to that of its prior year. In certain ones of such embodiments, the annual income change data is produced as a ratio of data representing income from the most recent reporting year to that of the prior year. In certain ones of such embodiments, the quarterly income change data is produced as an average of two ratios: a ratio of data representing income from the most recent reported quarter to that of the prior quarter and a ratio of data representing the corresponding quarter's income in the prior year to that of the immediately preceding quarter. In certain ones of such embodiments, the quarterly income change data is produced as a ratio of data representing income from the most recent reported quarter to that of the prior quarter.

In certain embodiments, the income risk factor data R19 is produced 944 by averaging the annual change data and the quarterly change data to produce income change value data in a manner that emphasizes the income trend in the more recent time period. In certain ones of such embodiments, income change value data is produced as the sum of the annual change data multiplied by a decimal between zero and one (e.g., 0.7) and the quarterly change data multiplied by the complement of such decimal (e.g., 0.3). Other decimal values may be selected, depending on the extent to which the more recent income data is to be emphasized. However, the income change value data may instead be produced from either the annual income change data or the quarterly change data alone, or else from one or more different periods, either alone or in combination with one or more others thereof, or with either or both of the annual income change data or the quarterly income change data. In any event, the income change value data is constrained so that it is greater than or equal to 0.1, representing an average 90% decrease in income.

In certain embodiments, the income risk factor data R19 is produced 944 as the reciprocal of the income change value data raised to a selected power which serves to scale the factor data R19 to give it appropriate emphasis in the production of the cash flow risk factor data C along with data representing the three other risk factors R18, R20 and R21. In certain ones of such embodiments, the selected power serves to scale the reciprocal of the income change value data to a relatively narrow range of values about the value “1”, so that the selected power is obtained as a value between “0” and “1”, such as 0.1.

In certain embodiments, the income risk factor data R19 is produced 944 as described hereinabove only if data representing the income value or values to be employed are positive. In certain ones of such embodiments, the income risk factor data R19 is only produced 944 as described hereinabove if data representing the latest annual income value is positive 948, and if not, the income risk factor data R19 is set to a value that reflects an increased risk evidenced by the entity's negative income, such as a value greater than “1” (for example, 1.1; see 952 in FIG. 13).

The operating cash flow (OCF) risk factor data R20 (916 in FIG. 13) is produced 956 in certain embodiments by selecting or producing data representing a trend or trends in the entity's OCF. In certain embodiments, this data is produced from a ratio of current period OCF data to OCF data from a prior period. In certain ones of such embodiments, annual OCF change data is produced as an average of two ratios: a ratio of OCF data from the most recent reporting year to that of the prior year and a ratio of such prior year's OCF data to that of its prior year. In certain ones of such embodiments, the annual operating cash flow change data is produced as a ratio of OCF data from the most recent reporting year to that of the prior year. In certain ones of such embodiments, the quarterly OCF change data is produced as an average of two ratios: a ratio of OCF data from the most recent reported quarter to that of the prior quarter and a ratio of the corresponding quarter's OCF data in the prior year to that of the immediately preceding quarter. In certain ones of such embodiments, the quarterly OCF change data is produced as a ratio of OCF data from the most recent reported quarter to that of the prior quarter.

In certain embodiments, the OCF risk factor data R20 is produced 956 by averaging the annual change data and the quarterly change data to produce OCF change value data in a manner that emphasizes the operating cash flow trend in the more recent time period. In certain ones of such embodiments, OCF change value data is produced as the sum of the annual change data multiplied by a decimal between zero and one (e.g., 0.7) and the quarterly change data multiplied by the complement of such decimal (e.g., 0.3). Other decimal values may be selected, depending on the extent to which the more recent OCF data is to be emphasized. However, the OCF change value data may instead be produced from either the annual OCF change data or the quarterly change data alone, or else from one or more different periods, either alone or in combination with one or more others thereof, or with either or both of the annual OCF change data or the quarterly OCF change data. In any event, the OCF change value data is constrained so that it is greater than or equal to 0.1, representing an average 90% decrease in OCF.

In certain embodiments, the operating cash flow risk factor R20 data is produced 956 as the reciprocal of the OCF change value data raised to a selected power which serves to scale the factor data R20 to give it appropriate emphasis in the production of the cash flow risk factor data C along with data representing the three other risk factors R18, R19 and R21. In certain ones of such embodiments, the selected power serves to scale the reciprocal of the OCF change value data to a relatively narrow range of values about the value “1”, so that the selected power is obtained as a value between “0” and “1”, such as 0.1.

In certain embodiments, the operating cash flow risk factor data R20 is produced 956 as described hereinabove only if data representing the OCF value or values to be employed are positive. In certain ones of such embodiments, the OCF risk factor data R20 is only produced 956 as described hereinabove if data representing the latest annual OCF value is positive 960, and if not, the OCF risk factor data R20 is set to a value that reflects an increased risk evidenced by the entity's negative OCF data, such as a value greater than “1” (for example, 1.05; see 964 in FIG. 13).

The free cash flow (FCF) risk factor data R21 (920 in FIG. 13) is produced 968 in certain embodiments by selecting or producing data representing a trend or trends in the entity's FCF. In certain embodiments, this data is produced from a ratio of data representing free cash flow for the current period to FCF from a prior period. In certain ones of such embodiments, annual FCF change data is produced as an average of two ratios: a ratio of data representing FCF for the most recent reporting year to that of the prior year and a ratio of such prior year's FCF to that of its prior year. In certain ones of such embodiments, the annual FCF change data is produced as a ratio of data representing FCF for the most recent reporting year to that of the prior year. In certain ones of such embodiments, the quarterly FCF change data is produced as an average of two ratios: a ratio of data representing FCF for the most recent reported quarter to that of the prior quarter and a ratio of the corresponding quarter's FCF in the prior year to that of the immediately preceding quarter. In certain ones of such embodiments, the quarterly FCF change data is produced as a ratio of data representing FCF for the most recent reported quarter to that of the prior quarter.

In certain embodiments, the FCF risk factor data R21 is produced 968 by averaging the annual change data and the quarterly change data to produce FCF change value data in a manner that emphasizes the FCF trend in the more recent time period. In certain ones of such embodiments, FCF change value data is produced as the sum of the annual change data multiplied by a decimal between zero and one (e.g., 0.7) and the quarterly change data multiplied by the complement of such decimal (e.g., 0.3). Other decimal values may be selected, depending on the extent to which the more recent FCF data is to be emphasized. However, the FCF change value data may instead be produced from either the annual FCF change data or the quarterly change data alone, or else from one or more different periods, either alone or in combination with one or more others thereof, or with either or both of the annual FCF change data or the quarterly FCF change data. In any event, the FCF change value data is constrained so that it is greater than or equal to 0.1, representing an average 90% decrease in FCF.

In certain embodiments, the FCF risk factor data R21 is produced as the reciprocal of the FCF change value data raised to a selected power which serves to scale the factor data R21 to give it appropriate emphasis in the production of the cash flow risk factor data C along with data representing the three other risk factors R18, R19 and R20. In certain ones of such embodiments, the selected power serves to scale the reciprocal of the FCF change value data to a relatively narrow range of values about the value “1”, so that the selected power is obtained as a value between “0” and “1”, such as 0.05.

Although various embodiments of the disclosed methods and systems have been described with reference to a particular arrangement of systems, devices, methods, features, functions and the like, these are not intended to exhaust all possible arrangements and implementations, and indeed many other embodiments, modifications and variations will be ascertainable to those of skill in the art.

What is claimed is:

1. A method for preparing a report providing at least one evaluation of a subject business entity's loss severity potential in the event of an insurable claim by one or more investors, comprising: accessing a database of securities class action settlement amount data for a plurality of business entities associated with data indicating a market capitalization of the respective business entities; and producing projected settlement data representing at least one projected securities settlement amount for the subject business entity based on the securities class action settlement amount data in the database and market capitalization data representing a market capitalization of the subject business entity.

2. A system for preparing a report providing at least one evaluation of a subject business entity's loss severity potential in the event of an insurable claim by one or more investors, comprising: storage storing securities class action settlement amount data distributed into a plurality of categories according to market capitalization data of corresponding business entities; a processor coupled with the storage to receive the securities class action settlement amount data; and an input configured to receive market capitalization data of the subject business entity; the processor being coupled with the input to receive the market capitalization data therefrom and configured to produce category data for the subject business entity based on the market capitalization data and to produce the report comprising projected settlement data representing at least one projected settlement amount based on the securities class action settlement amount data and the category data for the subject business entity.

3. A system for preparing a report providing at least one evaluation of a subject business entity's loss severity potential in the event of an insurable claim by one or more investors, comprising: storage storing securities class action settlement amount data for a plurality of business entities associated with data indicating a market capitalization of the respective business entities; a processor coupled with the storage to receive the securities class action settlement amount data; and an input configured to receive market capitalization data of the subject business entity; the processor being coupled with the input to receive the market capitalization data therefrom and configured to produce the report comprising projected settlement data representing at least one projected settlement amount based on the securities class action settlement amount data and the market capitalization data of the subject business entity.

4. A method of producing a database for producing a report providing at least one evaluation of a subject business entity's loss severity potential in the event of an insurable claim by one or more investors, comprising: receiving or accessing securities class action settlement data for a plurality of business entities and market capitalization data for such business entities; storing the securities class action settlement data and the market capitalization data in storage; categorizing the securities class action settlement data for the plurality of business entities in selected categories based on the market capitalization data of such business entities to produce categorized settlement data; and storing the categorized settlement data and category data identifying the categories of the categorized settlement data, in the storage.

5. The method of claim 4, comprising receiving or accessing further securities class action settlement data for a plurality of business entities and market capitalization data thereof at a time subsequent to a time of receiving or accessing the securities class action settlement data; categorizing the further securities class action settlement data based on the market capitalization data thereof to produce further categorized settlement data; and storing the further categorized settlement data and category data identifying the categories of the further categorized settlement data in the storage.

6. A system for producing a database for producing a report providing at least one evaluation of a subject business entity's loss severity potential in the event of an insurable claim by one or more investors, comprising: a data providing device; a processor coupled with the data providing device; and storage coupled with the processor; the processor being configured to receive securities class action settlement data for a plurality of business entities and market capitalization data for such business entities from the data providing device and to store the received data in the storage; the processor being configured to categorize the securities class action settlement data for the plurality of business entities in selected categories based on the market capitalization data of such business entities to produce categorized settlement data and to store the categorized settlement data and category data identifying the categories of the categorized settlement data, in the storage.

7. A method of producing a database for producing a report providing at least one evaluation of a subject business entity's loss severity potential in the event of an insurable claim by one or more investors, comprising: receiving or accessing securities class action settlement data for a plurality of business entities and market capitalization data for such business entities; producing a plurality of settlement range distribution data for a plurality of market capitalization levels based on the securities class action settlement data and the market capitalization data; and storing the plurality of settlement range distribution data in storage.

8. The method of claim 7, wherein the settlement range distribution data comprises a plurality of settlement range distributions each representing a range from a lowest settlement amount to a highest settlement amount, or for a portion of such a range, for a corresponding market capitalization or market capitalization interval.

9. The method of claim 7, wherein the settlement range distribution data comprises a plurality of distribution level curves each representing a predetermined point or interval within a plurality of settlement range distributions each corresponding to a different market capitalization or market capitalization range.

10. The method of claim 7, wherein the securities class action settlement data and the market capitalization data are stored at a selected time; and, at a time subsequent to the selected time, further securities class action settlement data for certain business entities and market capitalization data thereof are received or accessed, and a further plurality of settlement range distribution data are produced based on the securities class action settlement data and the further securities class action settlement data of the various business entities, along with the corresponding market capitalization data thereof.

11. A system for producing a database for producing a report providing at least one evaluation of a subject business entity's loss severity potential in the event of an insurable claim by one or more investors, comprising: a data providing device, a processor coupled with the data providing device, and storage coupled with the processor; the processor being configured to receive securities class action settlement data for a plurality of business entities and market capitalization data for such business entities from the data providing device; the processor being configured to produce a plurality of settlement range distribution data for a plurality of market capitalization levels based on the securities class action settlement data and the market capitalization data and to store the settlement range distribution data in the storage.
